(19) United States
(12) Patent Application Publication
(10) Pub. No.: US 2002/0016005 A1
(43) Pub. Date: Feb. 7, 2002

(54) Methods for detecting an acid or base in an environment, measuring the concentration of an acid or base in an environment, or measuring the PH of an environment and sensors thereof

(75) Inventors: Daniel P. Campbell, Atlanta, GA (US); Jeffrey L. Moore, Newark, DE (US); James V. Suggs, Corning, NY (US)

Correspondence Address: Mitchell A. Katz, NEEDLE & ROSENBERG, P.C., The Candler Building, Suite 1200, 127 Peachtree Street, N.E., Atlanta, GA, 30303-1811, US

(73) Assignee: Photonic Sensor Systems

(21) Appl. No.: 09/961,056

(22) Filed: Sep. 21, 2001

Related U.S. Application Data
(63) Continuation of application No. 09/183,517, filed on Oct. 30, 1998, now abandoned.

(51) Int. Cl. G01N 31/16

(52) U.S. Cl. 436/100; 436/163

(57) ABSTRACT

The invention relates to a method for detecting an acid or base in an environment, measuring the concentration of an acid or base in an environment, or measuring the pH of an environment, by contacting the environment containing the acid or the base with a sensor, wherein the sensor is composed of an index of refraction transducer having an outer surface; at least one compound having at least one functional group of a Lewis acid, a Lewis base, a Bronsted acid, a Bronsted base, or a combination thereof, wherein the compound is on or near the outer surface of the transducer, wherein the functional group can interact with the acid or base in the environment to induce a change in index of refraction on or near the outer surface of the transducer, with the provisos that (i) the compound does not undergo a color change when contacted with the acid or base, and (ii) when there are naturally occurring functional groups, no transducer attached compounds, and exactly one overlayer, then the overlayer is not poly(vinyl alcohol); a means for detecting or measuring the change of index of refraction, and a means for converting the change of index of refraction to a signal that corresponds to the detection of the acid or base in the environment, the concentration of the acid or base in the environment, or the pH of the environment, measuring the change of index of refraction, and converting the change of index of refraction to a signal that corresponds to the detection of the acid or base in the environment, the concentration of the acid or base in the environment, or the pH of the environment. The invention further relates to the sensors thereof.

This invention was made with government support under grants awarded by the Department of Energy (grant nos. DE-FC36-94GO10005 and DE-FC07-95-ID13352). The government may have certain rights in the invention.

### FIELD OF THE INVENTION

The present invention relates to methods for detecting an acid or base in an environment, measuring the concentration of an acid or base in an environment, or measuring the pH of an environment utilizing an index of refraction transducer and sensors thereof.

### BACKGROUND OF THE INVENTION

The development of sensors that can detect the presence of acids and bases in an environment has been the focus of considerable research. Typically, prior art sensors use a dye or color indicator that can react with the acid or base. Once the acid or base comes into contact with the dye or color indicator, the dye or color indicator changes color, which is indicative of a certain concentration of acid or base.

U.S. Pat. No. 4,846,548 to Klainer et al disclose the use of a fiber optic element covered with a clad or layer material that can react with a chemical or biological species in order to detect the chemical or biological species. Incorporated within the fiber or the clad is a fluorophore and an absorption dye, such as methyl violet, congo red, litmus, and phenol red. U.S. Pat. No. 5,082,629 to Burgess Jr. et al. disclose that a color indicator can be immobilized within an overcoat layer. The sensor of Burgess et al. can function as a pH measuring device. U.S. Pat. No. 5,315,673 to Stetter et al. disclose an optical waveguide sensor for the detection of acid vapors. A color indicator is incorporated in a Nafion® polymer film, which is applied to the surface of the sensor. Attridge et al. (J. of Physics E, vol. 20, pp. 548-553, 1987) disclose the incorporation of indicator dyes, such as phenolphthaleins or sulphophthaleins, into a polymer solution before casting into a film. A thin film is applied to the outer surface of the optical fiber in order to produce a pH sensor.

One problem associated with the color indicator sensors described above is that the number of color indicators or dyes available is limited with respect to measuring the pH of an acid or base over the entire pH range (i.e., from 0 to 14). Each color change indicator is restricted to a limited range, and it is difficult to incorporate and interpret multiple color change indicators in a single sensor. Therefore, prior art sensors can only detect or measure the concentration of an acid or base within a particular range as determined by the color indicator or dye. None of the art described above discloses the use of a sensor for detecting an acid or base in an environment, measuring the concentration of an acid or base in an environment, or measuring the pH of an environment without using an acid-base color indicator or dye.

Additionally, sensors that use index of refraction transducers that do not use the chemistry of this invention typically generate a relatively low signal to noise ratio when exposed to an acid or base. When the signal to noise ratio is low, it is more difficult to detect and measure the signal.

In light of the above, it would be very desirable to have a method for detecting an acid or base in an environment, measuring the concentration of an acid or base in an environment, or measuring the pH of an environment by using an index of refraction transducer that does not require the use of an acid-base color indicator or dye. In part, it would be advantageous to increase the possible response range with a single sensor.

Additionally, it would also be advantageous to increase the signal to noise ratio when the acid or base contacts the sensor so the response can be more readily measured. Finally, a sensor that is capable of selectively detecting an acid or base while excluding other components in the environment would be of considerable use as well.

### SUMMARY OF THE INVENTION

In accordance with the purpose(s) of this invention, as embodied and broadly described herein, this invention, in a first aspect, relates to a method for detecting an acid or base in an environment, measuring the concentration of an acid or base in an environment, or measuring the pH of an environment, comprising

(a) contacting the environment comprising the acid or the base with a sensor, comprising

(1) an index of refraction transducer having an outer surface;

(2) at least one compound comprising at least one functional group of a Lewis acid, a Lewis base, a Bronsted acid, a Bronsted base, or a combination thereof, wherein the compound is on or near the outer surface of the transducer, wherein the functional group can interact with the acid or base in the environment to induce a change in index of refraction on or near the outer surface of the transducer, with the provisos that

(i) the compound does not undergo a color change when contacted with the acid or base, and

(ii) when there are naturally occurring functional groups, no transducer attached compounds, and exactly one overlayer, then the overlayer is not poly(vinyl alcohol);

(3) a means for detecting or measuring the change of index of refraction, and

(4) a means for converting the change of index of refraction to a signal that corresponds to the detection of the acid or base in the environment, the concentration of the acid or base in the environment, or the pH of the environment,

(b) measuring the change of index of refraction, and

(c) converting the change of index of refraction to a signal that corresponds to the detection of the acid or base in the environment, the concentration of the acid or base in the environment, or the pH of the environment.

In another aspect, the invention relates to a method for detecting an acid or base in an environment, measuring the concentration of an acid or base in an environment, or measuring the pH of an environment, comprising the sensor and steps recited in the first aspect described above, with the exception that the sensor has at least one compound comprising at least one functional group of a Lewis acid, a Lewis base, a Bronsted acid, a Bronsted base, or a combination thereof, wherein the compound is on or near the outer surface of the transducer, wherein the functional group can facilitate the transfer of at least one proton between the compound and the acid or base in the environment, wherein the transfer of the proton induces a change in the index of refraction on or near the outer surface of the transducer, with the provisos that (i) the compound does not undergo a color change when contacted with the acid or base, and (ii) when there are naturally occurring functional groups, no transducer attached compounds, and exactly one overlayer, then the overlayer is not poly(vinyl alcohol).

In another aspect, the invention relates to a method for detecting an acid or base in an environment, measuring the concentration of an acid or base in an environment, or measuring the pH of an environment, comprising the sensor and steps recited in the first aspect described above, with the exception that the sensor has at least one compound attached to the transducer comprising at least one transducer attached compound functional group of a Lewis acid, a Lewis base, a Bronsted acid, a Bronsted base, or a combination thereof, wherein the transducer attached compound is on or near the outer surface of the transducer, wherein the transducer attached compound functional group can interact with the acid or base in the environment to induce a change in index of refraction on or near the outer surface of the transducer, with the proviso that the compound does not undergo a color change when contacted with the acid or base.

In another aspect, the invention relates to a method for detecting an acid or base in an environment, measuring the concentration of an acid or base in an environment, or measuring the pH of an environment, comprising the sensor and steps recited in the first aspect described above, with the exception that the sensor has at least one overlayer having an inner surface and an outer surface, wherein the overlayer has at least one overlayer having an inner surface and an outer surface, wherein the overlayer has at least one overlayer compound having at least one overlayer compound functional group of a Lewis acid, a Lewis base, a Bronsted acid, a Bronsted base, or a combination thereof incorporated within the overlayer, wherein the overlayer compound is on or near the outer surface of the transducer, wherein the inner surface of the overlayer is applied to the outer surface of the transducer, wherein the overlayer compound functional group can interact with the acid or base in the environment to induce a change of index of refraction on or near the outer surface of the transducer, with the provisos that (i) the compound does not undergo a color change when contacted with the acid or base, and (ii) when there are naturally occurring functional groups, no transducer attached compounds, and exactly one overlayer, then the overlayer is not poly(vinyl alcohol).

In another aspect, the invention relates to a method for detecting an acid or base in an environment, measuring the concentration of an acid or base in an environment, or measuring the pH of an environment, comprising the sensor and steps recited in the first aspect described above, with the exception that the sensor has

(1) at least one compound attached to the transducer comprising at least one transducer attached compound functional group of a Lewis acid, a Lewis base, a Bronsted acid, a Bronsted base, or a combination thereof, wherein the transducer attached compound is on or near the outer surface of the transducer, wherein the transducer attached compound functional group can interact with the acid or base in the environment to induce a change in index of refraction on or near the outer surface of the transducer, wherein the transducer attached compound does not undergo a color change when contacted with the acid or base, and

(2) at least one overlayer having an inner surface and an outer surface, wherein the overlayer has at least one overlayer compound having at least one overlayer compound functional group of a Lewis acid, a Lewis base, a Bronsted acid, a Bronsted base, or a combination thereof, incorporated within the overlayer, wherein the overlayer compound is on or near the outer surface of the transducer, wherein the inner surface of the overlayer is applied to the outer surface of the transducer, wherein the overlayer compound functional group can interact with the acid or base in the environment to induce a change of index of refraction on or near the outer surface of the transducer, with the proviso that the compound does not undergo a color change when contacted with the acid or base.

In another aspect, the invention relates to a sensor for detecting an acid or base in an environment, measuring the concentration of an acid or base in an environment, or measuring the pH of an environment, comprising

(a) an index of refraction transducer having an outer surface;

(b) at least one compound comprising at least one functional group of a Lewis acid, a Lewis base, a Bronsted acid, a Bronsted base, or a combination thereof, wherein the compound is on or near the outer surface of the transducer, wherein the functional group can interact with the acid or base in the environment to induce a change in index of refraction on or near the outer surface of the transducer, with the provisos that

(i) the compound does not undergo a color change when contacted with the acid or base, and

(ii) when there are naturally occurring functional groups, no transducer attached compounds, and exactly one overlayer, then the overlayer is not poly(vinyl alcohol);

(c) a means for detecting or measuring the change of index of refraction, and

(d) a means for converting the change of index of refraction to a signal that corresponds to the detection of the acid or base in the environment, the concentration of the acid or base in the environment, or the pH of the environment.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention.

### BRIEF DESCRIPTION OF THE DRAWINGS

FIG. 1 depicts one embodiment of the present invention. In this embodiment, the transducer attached compound X is indirectly attached to the transducer. In this embodiment, the compound and thus the functional group on the compound is attached to the transducer by a tether.

FIG. 2 depicts another embodiment of the present invention. In this embodiment, the transducer attached compound X is directly attached to the outer surface of the transducer. In this embodiment, there is no tether.

FIG. 3 depicts another embodiment of the present invention. In this embodiment, the overlayer comprises the first overlayer, wherein the first overlayer compound Z is contained in the first overlayer.

FIG. 4 depicts another embodiment of the present invention. In this embodiment, the overlayer comprises the second overlayer, wherein the second overlayer compound W is ionically, covalently, or hydrogen bonded to the second overlayer.

FIG. 5 depicts another embodiment of the present invention. In this embodiment, the overlayer comprises the third overlayer, wherein the third overlayer compound W is ionically, covalently, or hydrogen bonded to the third overlayer and the third overlayer compound Z is contained in the third overlayer.

FIGS. 6a and 6b depict one embodiment of the present invention, where glutamic acid is attached to the waveguide and the overlayer is poly(2-hydroxyethyl methacrylate).

FIG. 6a depicts proton transfer between the base (—OH), water, and the functional group of glutamic acid (carboxylic acid).

FIG. 6b shows the stabilization of the negative charge among the carboxylate groups of glutamic acid and the charge separation between the negatively charged carboxylate groups and the counterion (Na⁺).

FIG. 7 is a schematic drawing of a sensor typically used in various embodiments of the invention.

FIG. 8 shows the pH response of a sensor with only naturally-occurring surface hydroxyl groups attached to the waveguide.

FIG. 9 shows the pH response of a sensor when glutamic acid is indirectly attached to the outer surface of the waveguide by a silyl compound.

FIG. 10 shows the pH response of a sensor when glutamic acid is indirectly attached to the outer surface of the waveguide by a silyl compound and (1) poly(2-hydroxyethyl methacrylate) is not applied to the outer surface of the waveguide and (2) poly(2-hydroxyethyl methacrylate) is applied to the outer surface of the waveguide.

FIG. 11 shows the response to ammonia when a sensor having polyethyleneimine-80% ethoxylated/citric acid on the outer surface of the waveguide is exposed to ammonia.

FIG. 12 shows the response to ammonia when a sensor having poly(vinyl phenol) on the outer surface of the waveguide is exposed to ammonia.

### DETAILED DESCRIPTION OF THE INVENTION

The present invention may be understood more readily by reference to the following detailed description of preferred embodiments of the invention and the Examples included therein.

Before the present methods and sensors are disclosed and described, it is to be understood that this invention is not limited to specific synthetic methods or to particular formulations, as such may, of course, vary. It is also to be understood that the terminology used herein is for the purpose of describing particular embodiments only and is not intended to be limiting.

In this specification and in the claims which follow, reference will be made to a number of terms which shall be defined to have the following meanings:

The singular forms “a,” “an” and “the” include plural referents unless the context clearly dictates otherwise.

“Optional” or “optionally” means that the subsequently described event or circumstance may or may not occur, and that the description includes instances where said event or circumstance occurs and instances where it does not.

The term “environment” as used herein is a gas media, liquid media, or a combination thereof. When the environment is a liquid media, the liquid media can be an aqueous or organic media.

The term “color change” is defined as a visible or near-infrared region (approximately from 400 to 700 nm) spectrum change.

The term “index of refraction transducer” refers to any number of devices well-known in the art that can detect or measure the change of the index of refraction. Index of refraction devices are typically electromagnetic. Some optical transducers known in the art are index of refraction transducers. The transducers of the present invention are typically made from organic materials such as polyimide or inorganic materials such as silicon dioxide, tantalum pentoxide, titanium dioxide, silicon nitride, borosilicate glasses, or borosilicate glasses doped with silver. In one embodiment, the transducer comprises a fiber optic evanescent wave sensor, a planar optic evanescent wave sensor, an integrated optic interferometer, a directional coupler, a grating coupler, a resonant mirror, an ellipsometer, a refractometer, or a surface plasmon resonance device. In a preferred embodiment, the transducer is an integrated optic interferometer. An index of refraction transducer useful in the present invention can be found in, for example, U.S. Pat. No. 5,623,561 to Hartman, which is herein incorporated by this reference in its entirety.

The term “interact” as used herein with respect to the present invention refers to the ability of the acid or base in the environment to undergo, for example, covalent bonding, ionic bonding, dative bonding, or hydrogen bonding with the functional group in order to induce a change of index of refraction. For example, if the environment contains ammonia and the functional group is a Lewis acid, then the interaction between the Lewis acid and the ammonia involves the donation of the lone pair electrons from ammonia to the Lewis acid (i.e. dative bonding). If the functional group is a Bronsted acid, then the Bronsted acid interacts with ammonia by protonating ammonia to produce an ammonium ion (NH₄⁺).

The term “transducer attached compound” refers to a compound that is either directly attached to the transducer or indirectly attached to the transducer. The transducer attached compound acts as the sensing compound that senses the acid or base in the environment to produce a change in the index of refraction. When the compound is attached to the outer surface of the transducer by a covalent bond, an ionic bond, or a hydrogen bond, then the compound is “directly” attached to the transducer. When the compound is attached to the transducer by a tether, then the compound is “indirectly” attached to the transducer. The tether is a chain or linker that connects the compound to the transducer. The functional group that is present on the transducer attached compound may also specifically be directly or indirectly attached to the transducer. The functional group is directly attached to the transducer when there is no interceding tether or part of the compound between the functional group and its bonding to the transducer.

The term “overlayer” refers to the layer incorporating a compound having at least one functional group of a Lewis acid, a Lewis base, a Bronsted acid, a Bronsted base, or a combination thereof that is applied to the outer surface of the transducer and that facilitates sensing the acid or base in the environment by producing a change in the index of refraction.

The term “excluding layer” refers to the layer that is applied to the outer surface of the transducer or overlayer that shields the transducer or overlayer or both from undesirable environmental effects.

The term “juxtaposed” refers to the intimate contact between two surfaces (e.g., the overlayer and the outer surface of the transducer).

The term “applied to the outer surface” is intended to mean herein juxtaposed with the outer surface or in proximity to the outer surface with one or more interceding layers. The term “applied to the outer surface of the transducer” with respect to the overlayer is intended to include the overlayer being juxtaposed with the outer surface of the transducer or being applied in proximity to the outer surface of the transducer with one or more interceding layers existing between the outer surface of the transducer and the overlayer. Similarly, the term “applied to the outer surface of the transducer” with respect to the excluding layer includes the excluding being juxtaposed with the outer surface of the transducer or being applied in proximity to the outer surface of the transducer with one or more interceding layers existing between the outer surface of the transducer and the excluding layer. The order in which the overlayer and the excluding layer are applied to the outer surface of the transducer can vary. For example, the overlayer can be juxtaposed to the outer surface of the transducer or to the outer surface of the excluding layer and/or the excluding layer can be juxtaposed with the outer surface of the transducer or the outer surface of the overlayer. hi another example, one or more interceding layers can be present between the transducer and the overlayer, transducer and excluding layer, and/or overlayer and the excluding layer. In a specific embodiment, an overlayer is applied to the outer surface of the transducer, and an excluding layer is applied to the outer surface of the overlayer. In another specific embodiment, an overlayer is juxtaposed with the outer surface of the transducer. In another specific embodiment, an overlayer is juxtaposed with the outer surface of the transducer and an excluding layer is juxtaposed with the outer surface of the overlayer.

The term “on or near the outer surface of the transducer” means on the outer surface of the transducer or within 10,000 nm of the outer surface of the transducer.

In accordance with the purpose(s) of this invention, as embodied and broadly described herein, this invention, in one aspect, relates to a method for detecting an acid or base in an environment, measuring the concentration of an acid or base in an environment, or measuring the pH of an environment, comprising

(a) contacting the environment comprising the acid or the base with a sensor, comprising

(1) an index of refraction transducer having an outer surface;

(2) at least one compound comprising at least one functional group of a Lewis acid, a Lewis base, a Bronsted acid, a Bronsted base, or a combination thereof, wherein the compound is on or near the outer surface of the transducer, wherein the functional group can interact with the acid or base in the environment to induce a change in index of refraction on or near the outer surface of the transducer, with the provisos that

(i) the compound does not undergo a color change when contacted with the acid or base, and

(ii) when there are naturally occurring functional groups, no transducer attached compounds, and exactly one overlayer, then the overlayer is not poly(vinyl alcohol);

(3) a means for detecting or measuring the change of index of refraction, and

(4) a means for converting the change of index of refraction to a signal that corresponds to the detection of the acid or base in the environment, the concentration of the acid or base in the environment, or the pH of the environment,

(b) measuring the change of index of refraction, and

(c) converting the change of index of refraction to a signal that corresponds to the detection of the acid or base in the environment, the concentration of the acid or base in the environment, or the pH of the environment.

In another aspect, the invention relates to a method for detecting an acid or base in an environment, measuring the concentration of an acid or base in an environment, or measuring the pH of an environment, comprising

(a) contacting the environment comprising an acid or a base with a sensor, comprising

(1) an index of refraction transducer having an outer surface;

(2) at least one compound comprising at least one functional group of a Lewis acid, a Lewis base, a Bronsted acid, a Bronsted base, or a combination thereof, wherein the compound is on or near the outer surface of the transducer, wherein the functional group can facilitate the transfer of at least one proton between the compound and the acid or base in the environment, wherein the transfer of the proton induces a change in the index of refraction on or near the outer surface of the transducer, with the provisos that

(i) the compound does not undergo a color change when contacted with the acid or base, and

(ii) when there are naturally occurring functional groups, no transducer attached compounds, and exactly one overlayer, then the overlayer is not poly(vinyl alcohol);

(3) a means for detecting or measuring the change of index of refraction, and

(4) a means for converting the change of index of refraction to a signal that corresponds to the detection of the acid or base in the environment, the concentration of the acid or base in the environment, or the pH of the environment,

(b) measuring the change of index of refraction, and

(c) converting the change of index of refraction to a signal that corresponds to the detection of the acid or base in the environment, the concentration of the acid or base in the environment, or the pH of the environment.

In this invention, when there are naturally occurring functional groups, no transducer attached compounds, and exactly one overlayer, then the overlayer is not poly(vinyl alcohol). However, it should be understood that the use of the term poly(vinyl alcohol) in the proviso is restricted to poly(vinyl alcohol) alone, that is, poly(vinyl alcohol) not incorporating other functional groups.

A portion or the entire outer surface of the transducer, either on the transducer surface or near the transducer surface, can be treated with a compound having at least one functional group in order to produce a change in the index of refraction when the functional group interacts with the acid or base. The compound that can interact with the environment comprises a Lewis acid, a Lewis base, a Bronsted acid, a Bronsted base, or a combination thereof. Depending upon the conditions in the environment, the functional group can behave as a Lewis acid, Lewis base, a Bronsted acid, and/or a Bronsted base.

Some prior art sensors have functional groups already naturally attached to the outer surface of the transducer prior to this instant invention's methods of attaching (a) an additional amount of the same functional group, (b) a different functional group, or (c) a compound having a functional group to the outer surface of the transducer. For example, a transducer composed of silicon dioxide or silicon nitride has hydroxyl (—OH) or amino groups (—NH₂), respectively, attached to the outer surface of the transducer. These groups are referred to herein as “naturally-occurring functional groups.” In another words, a compound having a functional group of this invention can be attached to the outer surface of the transducer by a chemical reaction, while naturally-occurring functional groups are inherently present on the outer surface of the transducer. Thus, an acid treatment of silicon dioxide can add additional hydroxyl groups to the surface of the transducer, and such additional hydroxyl groups would not be considered naturally occurring. Similarly, an amino acid or peptide can be chemically bonded to the surface of the transducer, which would not be naturally occurring.

The functional groups of the present invention do not change color when they interact with the acid or base as is the case with certain prior art methods. Instead, the instant invention changes a dipole when an acid or base interacts with the functional groups of the present invention, which produces an index of refraction change for the acid or base of a particular pKa and concentration. The index of refraction change produced by the acid or base is also dependent upon the selection of the functional group on the compound. When the functional group is a Bronsted acid or Bronsted base, the interaction involves proton transfer between the functional group and the acid or base. When the functional group is a Lewis acid or Lewis base, the interaction involves donating or accepting an electron pair between the functional group and the acid or base.

The functional group can be any Lewis acid or Lewis base known in the art. The Lewis acids of the present invention include, but are not limited to, aluminum compounds, boron compounds, a proton (H⁺), or a combination thereof. Non-limiting examples of Lewis bases are transition metal carbonyl compounds, transition metal phosphine compounds, transition metal phosphite compounds, or a combination thereof. Examples of Lewis acids and Lewis bases are disclosed in Advanced Inorganic Chemistry: A Comprehensive Text, Interscience, New York, 1972, which is herein incorporated by this reference in its entirety.

The functional group can be any Bronsted acid or Bronsted base known in the art. The Bronsted acids useful in the present invention include, but are not limited to, water, a proton (H⁺), an amino acid, a carboxylic acid, an organophosphoric acid, an organosulfuric acid, a protonated nitrogen compound, an alcohol, a thiol, an activated methylene compound, an organonitro compound, or a combination thereof. Typical protonated nitrogen compounds include, but are not limited to, amines, amidines, imines, or guanidines. Useful activated methylene compounds include, but are not limited to, malonates or malonitrile. Examples of malonates include, but are not limited to, derivatives of malonic acid, malonic amides, or malonic esters. When the malonate is attached to the surface of the transducer or the overlayer, the attachment is facilitated by the use of the malonate amide or malonate ester.

Examples of Bronsted bases include, but are not limited to, water, a hydroxide, a carboxylate, an organophosphonate, an organosulfonate, a neutral nitrogen compound, an alkoxide, a thioalkoxide, a conjugate base of a methylene compound, a conjugate base of an organonitro compound, an amino acid, an amine, an amide, an imine, or a combination thereof.

The compound having the functional group is on or near the outer surface of the transducer. When the compound is directly attached to the outer surface of the transducer by a covalent bond, ionic bond, or hydrogen bond, the compound is “on” the outer surface of the transducer. When the compound is indirectly attached or is not directly attached to the outer surface of the transducer, but the compound is within 10,000 nm from the outer surface of the transducer, the compound is “near” the transducer. Such indirect attachment includes, but is not limited to, the use of a tether that connects the transducer to the compound having the functional group. Such nonattachment of the transducer includes, but is not limited to, the compound having the functional group being contained in an overlayer. Thus, in all cases, “on or near” refers to the compound and its functional group being within 10,000 nm of the outer surface of the transducer. The term “outer surface” is defined as the portion of the transducer that is exposed to the environment.

I. Optical Transducers with a Transducer Attached Compound-Methods

In a specific embodiment of the above general embodiments of the present invention, the invention relates to a method for detecting the presence of an acid or base in an environment, measuring the concentration of an acid or base in an environment, or measuring the pH of an environment, comprising

(a) contacting the environment comprising the acid or the base with a sensor, comprising

(1) an index of refraction transducer having an outer surface;

(2) at least one compound attached to the transducer comprising at least one transducer attached compound functional group of a Lewis acid, a Lewis base, a Bronsted acid, a Bronsted base, or a combination thereof, wherein the transducer attached compound is on or near the outer surface of the transducer, wherein the transducer attached compound functional group can interact with the acid or base in the environment to induce a change in index of refraction on or near the outer surface of the transducer, with the proviso that the compound does not undergo a color change when contacted with the acid or base;

(3) a means for detecting or measuring the change of index of refraction, and

(4) a means for converting the change of index of refraction to a signal that corresponds to the detection of the acid or base in the environment, the concentration of the acid or base in the environment, or the pH of the environment,

(b) measuring the change of index of refraction, and

(c) converting the change of index of refraction to a signal that corresponds to detecting the acid or base in the environment, the concentration of the acid or base in the environment, or the pH of the environment.

As used herein, transducer attached compound does not include naturally occurring functional groups.

Examples of this embodiment are when the transducer attached compound comprises an amino acid, 2-ethyl pyridine, 4-aminobenzoic hydrazide, 4-aminobenzoic acid, 4-hydroxybenzoic acid, 3-hydroxytyramine, or the carboxylic acid of the oxidation product of 3-glycidyloxypropyldimethylethoxysilane. The amino acid can be a natural amino acid or non-natural amino acid. In the case of the amino acid, the amino acid preferably comprises glutamic acid, tyrosine, arginine, aspartic acid, cysteine, lysine, histidine, or a combination thereof The transducer attached compound can be a peptide or polypeptide. The peptide or polypeptide preferably comprises the repeat units of glutamic acid, tyrosine, arginine, aspartic acid, cysteine, lysine, histidine, or a combination thereof. The number of amino acids used to prepare the peptide or polypeptide can vary depending upon the desired number of transducer attached compound functional groups. In another embodiment, a peptide or polypeptide and an amino acid can be attached to the outer surface of the transducer simultaneously.

A peptide or polypeptide can be prepared and attached to the transducer using techniques known in the art. In one embodiment, once the amino acid is attached the transducer, additional amino acids can be added in order to build up the peptide chain, which results in the formation of a peptide or polypeptide on the outer surface of the transducer. In another embodiment, the peptide or polypeptide can be prepared and purified prior to attaching the peptide or polypeptide to the transducer. In a specific embodiment, the amino acid of one peptide or polypeptide can be bonded with an amino acid of a second peptide or polypeptide, wherein both peptides or polypeptides are attached to the outer surface of the transducer.

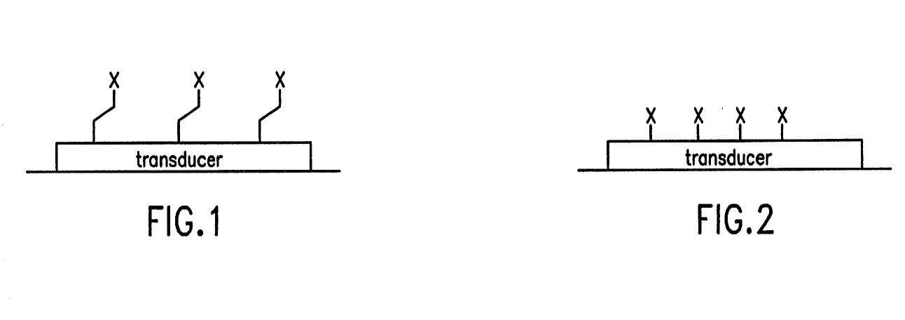

FIGS. 1 and 2 depict when the transducer attached compound X is indirectly and directly attached to the outer surface of the transducer, respectively. Specifically in FIG. 1, the transducer attached compound X is indirectly attached to the outer surface of the transducer by a tether. The tether is attached to the transducer by an ionic bond, covalent bond, or hydrogen bond. For example, the tether can comprise a short carbon chain having from 1 to 20 carbon atoms. The tether may possess one or more functional groups at any point along the tether or no functional groups at all. Typically, the terminal end of the tether has a group that can be used to attach the sensing compounds of the present invention to the tether. Examples of terminal groups include, but are not limited to, a ketone, an aldehyde, an amine, a carboxylic acid, a halide, an acid chloride, an alcohol, an alkene, a nitrile, an epoxide, an alkyne, or a thiol. Using techniques known in the art, it is possible to attach the sensing compound chemically to the tether.

When the transducer attached compound is indirectly attached to the transducer by a tether, the tether can be attached to the transducer using techniques known in the art. For example, when the transducer is a polymer possessing a carboxylic acid group, the carboxylic acid can be esterified by reacting a tether compound that has a terminal hydroxyl group with the carboxylic acid group. In another example, when the transducer is silicon dioxide, the tether can be attached using silane coupling chemistry, where the silyl group forms a covalent bond with the hydroxyl groups on the outer surface of the silicon dioxide. Techniques for using silane coupling chemistry are disclosed in Silane Coupling Agents, 2^{nd} Ed., Plenum Publishing, New York, 1991 and Silylated Surfaces, Gordon and Breach, New York, 1980, which are herein incorporated by this reference in their entirety. The silane coupling agent is, preferably, 3-glycidyloxypropyldimethylethoxysilane. In a preferred embodiment, glutamic acid is attached to the outer surface of the transducer using 3-glycidyloxypropyldimethylethoxysilane.

In FIG. 2, when the transducer attached compound X is directly attached to the outer surface of the transducer, the transducer attached compound is attached to the outer surface of the transducer by a covalent, ionic, or hydrogen bond without an intervening tether. An example of a transducer attached compound directly attached to the outer surface of the transducer is when the transducer attached compound functional group is the entire transducer attached compound. Examples of this embodiment include, but are not limited to, a hydroxyl group or an amine group that is covalently bonded to the outer surface of the transducer. In a preferred embodiment, the functional group is a hydroxyl group. When a transducer composed of silicon dioxide, which has naturally-occurring hydroxyl groups, is treated with an acid, a plurality of hydroxyl groups are produced on the outer surface of the transducer. By increasing the number of surface hydroxyl groups attached to the outer surface of the transducer, the ability of the sensor to detect an acid or base, measure the concentration of the acid or base, or measure the pH of the environment also increases. The hydroxyl groups (naturally-occurring or added by acid treatment) attached to the outer surface of the transducer can also be converted to the chloro group by the reaction shown in equation 1. This reaction is disclosed in Trans. Faraday Soc., 57, 2000, 1961, which is herein incorporated by this reference in its entirety.

Si—OH+SO₂Cl₂→Si—Cl+HCl+SO₂ (1)

Thus, in one embodiment, the transducer attached compound can be directly attached to the outer surface of the transducer by reacting the transducer attached compound with the transducer having at least one chloro group on the outer surface of the transducer, wherein the transducer attached compound displaces the chloro group. For example, the chlorinated glass produced in equation 1 can be reacted with ammonia to convert the chloro groups to surface amine groups (equation 2). This reaction is disclosed in J. Phys. Chem., 70, 2937, 1966, which is herein incorporated by this reference in its entirety.

Si—Cl+2NH₃→Si—NH₂+NH₄Cl (2)

Alternatively, the chloro groups can be converted to lithium using techniques known in the art. In this embodiment, the outer surface can chemically react with the sensing compound or tether compound in order to attach the sensing compound or tether to the outer surface of the transducer.

In another embodiment, the transducer attached compound comprises two or more transducer attached compound functional groups, wherein one of the transducer attached compound functional groups is directly attached to the outer surface of the transducer and one of the transducer attached compound functional groups is indirectly attached to the outer surface of the transducer. The transducer attached compound functional groups can be the same as each other or different. As an example of this embodiment, an amino acid is directly attached to the outer surface of the transducer through the amino group using a reaction similar to the reaction in equation 2, while the carboxylic acid group is indirectly attached to the outer surface of the transducer.

II. Optical Transducers with an Overlayer-Methods

In another specific aspect, the invention relates to a method for detecting an acid or base in an environment, measuring the concentration of an acid or base in an environment, or measuring the pH of an environment, comprising

(a) contacting the environment comprising the acid or the base with a sensor, comprising

(1) an index of refraction transducer having an outer surface;

(2) at least one overlayer having an inner surface and an outer surface, wherein the overlayer has at least one overlayer compound having at least one overlayer compound functional group of a Lewis acid, a Lewis base, a Bronsted acid, a Bronsted base, or a combination thereof incorporated within the overlayer, wherein the overlayer compound is on or near the outer surface of the transducer, wherein the inner surface of the overlayer is applied to the outer surface of the transducer, wherein the overlayer compound functional group can interact with the acid or base in the environment to induce a change of index of refraction on or near the outer surface of the transducer, with the provisos that

(i) the compound does not undergo a color change when contacted with the acid or base, and

(ii) when there are naturally occurring functional groups, no transducer attached compounds, and exactly one overlayer, then the overlayer is not poly(vinyl alcohol);

(3) a means for detecting or measuring the change of index of refraction, and

(4) a means for converting the change of index of refraction to a signal that corresponds to the detection of the acid or base in the environment, the concentration of the acid or base in the environment, or the pH of the environment,

(b) measuring the change of index of refraction, and

(c) converting the change of index of refraction to a signal that corresponds to the detection of the acid or base in the environment, the concentration of the acid or base in the environment, or the pH of the environment.

The invention further relates to a method for detecting the presence of an acid or base in an environment, measuring the concentration of an acid or base in an environment, or measuring the pH of an environment, comprising

(a) contacting the environment comprising the acid or the base with a sensor, comprising

(1) an index of refraction transducer having an outer surface;

(2) at least one compound attached to the transducer comprising at least one transducer attached compound functional group of a Lewis acid, a Lewis base, a Bronsted acid, a Bronsted base, or a combination thereof, wherein the transducer attached compound is on or near the outer surface of the transducer, wherein the transducer attached compound functional group can interact with the acid or base in the environment to induce a change in index of refraction on or near the outer surface of the transducer, wherein the transducer attached compound does not undergo a color change when contacted with the acid or base;

(3) at least one overlayer having an inner surface and an outer surface, wherein the overlayer has at least one overlayer compound having at least one overlayer compound functional group of a Lewis acid, a Lewis base, a Bronsted acid, a Bronsted base, or a combination thereof, incorporated within the overlayer, wherein the overlayer compound is on or near the outer surface of the transducer, wherein the inner surface of the overlayer is applied to the outer surface of the transducer, wherein the overlayer compound functional group can interact with the acid or base in the environment to induce a change of index of refraction on or near the outer surface of the transducer, with the proviso that the compound does not undergo a color change when contacted with the acid or base;

(4) a means for detecting or measuring the change of index of refraction, and

(5) a means for converting the change of index of refraction to a signal that corresponds to the detection of the acid or base in the environment, the concentration of the acid or base in the environment, or the pH of the environment,

(b) measuring the change of index of refraction, and

(c) converting the change of index of refraction to a signal that corresponds to detecting the acid or base in the environment, the concentration of the acid or base in the environment, or the pH of the environment.

The outer surface of the transducer can be treated or coated with an overlayer whose refractive index varies in response to an acid or base in the environment. The overlayer of the present invention does not undergo a color change when contacted with the acid or base. Generally, the overlayer is optically clear. The overlayer can be applied to the outer surface of the transducer when a transducer attached compound is present or absent.

The overlayer compound is on, close to, or near the outer surface of the transducer. The phrase “at least one overlayer compound having at least one overlayer compound functional group incorporated within the overlayer” as used herein refers to (1) an overlayer compound having at least one overlayer compound functional group contained in the overlayer (e.g., at the inner surface, outer surface, and/or the middle of the polymer) without chemically interacting with the overlayer, such as by admixing the overlayer compound with the overlayer, or (2) the overlayer compound functional group is attached to the overlayer or part of the overlayer backbone by a covalent bond, ionic bond, or hydrogen bond. Any of the transducer attached compound functional groups or transducer attached compounds possessing at least one transducer attached compound functional group discussed in the previous section can be used in this embodiment of the invention.

The thickness of the overlayer can vary depending upon the environment and the composition of the overlayer. The overlayer has a thickness of from 1 to 10,000 nm, preferably from 10 to 1,000 nm, more preferably from 100 to 800 nm, and even more preferably from 400 to 600 nm. In one embodiment, when the transducer produces an evanescent field, the overlayer is thicker than the evanescent field.

The overlayer preferably comprises a wax, a porous glass, a sol-gel, a membrane, an ormosil (an organically modified silica), a polymer, or a combination thereof. Examples of waxes useful in the present invention include, but are not limited to, naturally occurring waxes such as beeswax, and synthetic waxes such as parrafin. Examples of membranes include, but are not limited to, lipid bilayers, LangmuirBlodgett films, self-assembled monolayers (SAMs), tortuous path membranes, and non-tortuous path membranes. Examples of non-tortuous path membranes include, but are not limited to, drilled hole polycarbonate membranes. Examples of tortuous path membranes include, but are not limited to, mixed ester membranes, cellulose membranes, Nafion® membranes, or poly(vinylidene fluoride) membranes.

In a preferred embodiment, the overlayer comprises a polymer layer. The polymer layer can be a homopolymer, a copolymer, a terpolymer, or a combination thereof. The molecular weight of the polymer layer is generally high enough so that the polymer layer maintains its structural integrity after it has been applied to the outer surface of the transducer.

Examples of overlayers useful in the present invention include, but are not limited to,

(a) at least one first overlayer having at least one first overlayer contained compound having at least one first overlayer contained compound functional group comprising a Lewis acid, Lewis base, Bronsted acid, a Bronsted base, or a combination thereof, wherein the first overlayer contained compound is contained in the first overlayer,

(b) at least one second overlayer having at least one second overlayer bonded compound having at least one second overlayer bonded compound functional group comprising a Lewis acid, a Lewis base, a Bronsted acid, or a Bronsted base, wherein the second overlayer bonded compound is covalently, ionically, or hydrogen bonded to the second overlayer, or

(c) at least one third overlayer comprising (1) at least one third overlayer bonded compound having at least one third overlayer bonded compound functional group comprising a Lewis acid, a Lewis base, a Bronsted acid, or a Bronsted base, wherein the third overlayer bonded compound is covalently, ionically, or hydrogen bonded to the third overlayer and (2) a third overlayer contained compound having at least one third overlayer contained compound functional group comprising a Lewis acid, a Lewis base, a Bronsted acid, or a Bronsted base, wherein the third overlayer contained compound is contained in the third overlayer,

or a combination thereof.

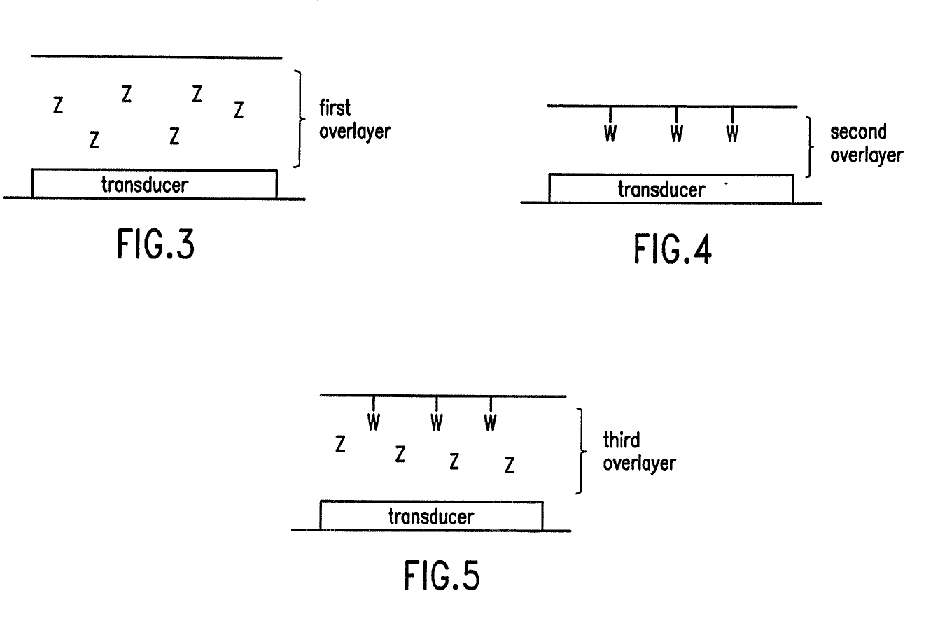

In embodiment (a) above, the first overlayer has at least one first overlayer contained compound. FIG. 3 depicts this embodiment of the present invention, where Z is the first overlayer contained compound having at least one first overlayer contained compound functional group. The first overlayer preferably comprises a polyolefin such as polytetrafluoroethylene, polyethylene, or polyisobutylene and the first overlayer contained compound preferably comprises a phenol. Any of the phenols described in the previous section can be used in this embodiment.

In embodiment (b) above, the overlayer comprises the second overlayer. The second overlayer has at least one second overlayer bonded compound having at least one second overlayer bonded compound functional group chemically attached to the second overlayer. The second overlayer bonded compound can be a pendant group, where the compound is ionically, covalently, or hydrogen bonded to the overlayer. FIG. 4 depicts this embodiment of the present invention, where W is the pendant second overlayer bonded compound. The second overlayer bonded compound can also be part of the overlayer backbone. Alternatively or additionally, the second overlayer bonded compound can consist only of the functional group, that is, the second overlayer bonded compound is merely a functional group, such as a pendant hydroxyl group attached to the overlayer or an amino group incorporated within the backbone chain of the overlayer. An example of an overlayer that has a second overlayer bonded compound incorporated within the backbone includes, but is not limited to, polyethyleneimine, wherein the amine nitrogens are the second overlayer bonded compound and also the second overlayer bonded compound functional group.

The second overlayer preferably comprises, for example, poly(vinyl phenol), polystyrene sulfate (sodium salt), polyethyleneimine, poly(acrylic acid), or a combination thereof. In a preferred embodiment, the second overlayer comprises poly(vinyl phenol). In this example, the phenol is the second overlayer bonded compound and the hydroxyl group of the phenol is the second overlayer bonded compound functional group.

In embodiment (c) above, the overlayer comprises the third overlayer. The third overlayer has at least one third overlayer bonded compound having at least one third overlayer bonded compound functional group, wherein the third overlayer bonded compound is chemically attached to the third overlayer and at least one third overlayer contained compound having at least one third overlayer contained compound functional group, wherein the third overlayer contained compound is contained in the overlayer. The third overlayer contained compound that is contained in the overlayer may chemically interact the third overlayer bonded compound functional group attached to the overlayer. FIG. 5 depicts this embodiment of the present invention, where W is the third overlayer bonded compound that is chemically attached to the third overlayer and Z is the third overlayer contained compound. The third overlayer compounds W and Z can be the same or different.

One example of a third overlayer includes, but is not limited to, titrating polyethyleneimine with an acid in water, wherein the acid comprises citric acid, phosphoric acid, tartaric acid, maleic acid, or acetic acid, preferably citric acid. In this embodiment, polyethyleneimine is titrated with the acid to a particular pH, wherein the acid forms an ionic bond with the nitrogen atoms of polyethyleneimine. When the polyethyleneimine-citric acid is cast from water, the polyethyleneimine-citric acid is the third overlayer bonded compound and the water is the third overlayer contained compound. The water is contained in the overlayer because it is hydroscopic. Another example of the third overlayer includes, but is not limited to, admixing an amino acid such as glutamic acid, aspartic acid, cysteine, arginine, lysine, tyrosine, histidine, or a combination thereof (i.e., the third overlayer contained compound) with poly(2-hydroxyethyl methacrylate) (i.e., the third overlayer bonded compound). Another example of the third overlayer involves admixing poly(2-hydroxypropyl acrylate) with water or a phenol compound such as 2-napthol, 4-nitrophenol, chlorophenol, or dichlorophenol.

When two or more overlayers are used, the overlayers can be admixed prior to applying to the outer surface of the transducer. For example, poly(2-hydroxypropyl acrylate) can be admixed with poly(vinyl phenol). Alternatively, the overlayers can be applied sequentially to the outer surface of the transducer to produce a laminate.

In an alternative embodiment, the overlayer can be applied to the outer surface of the transducer when a transducer attached compound having a functional group is attached to the outer surface of the transducer. The overlayer is in contact with the transducer attached compound and the transducer. One example of this embodiment includes a transducer attached compound consisting of the transducer attached compound functional group, wherein the transducer attached compound functional group is directly attached to the outer surface of the transducer, and an overlayer applied to the outer surface of the transducer. A specific example of this embodiment is when (1) the transducer attached compound consists of a plurality of (non-natural) hydroxyl groups, wherein the hydroxyl groups are directly attached to the outer surface of the transducer, and (2) the overlayer comprises poly(vinyl alcohol). Another specific example is when (1) the transducer attached compound is glutamic acid, wherein the glutamic acid is indirectly attached to the outer surface of the waveguide by a silyl compound, and (2) the overlayer comprises poly(2-hydroxyethyl methacrylate). Yet another specific example is when (1) the transducer attached compound is a peptide comprising the repeat units of glutamic acid, aspartic acid, arginine, lysine, tyrosine, cysteine, or histidine or a combination thereof, and (2) the overlayer comprises poly(2-hydroxyethyl methacrylate).

When naturally-occurring functional groups are the only transducer attached compounds present on the outer surface of the transducer, any overlayer of the present invention can be applied to the outer surface of the transducer with the exception of poly(vinyl alcohol). For example, the present invention is not intended to include a sensor consisting of a silicon dioxide transducer, which only has naturally-occurring hydroxyl groups, and an overlayer of poly(vinyl alcohol) in order to detect an acid or base in an environment, measure the concentration of an acid or base in and environment, or measure the pH of the environment.

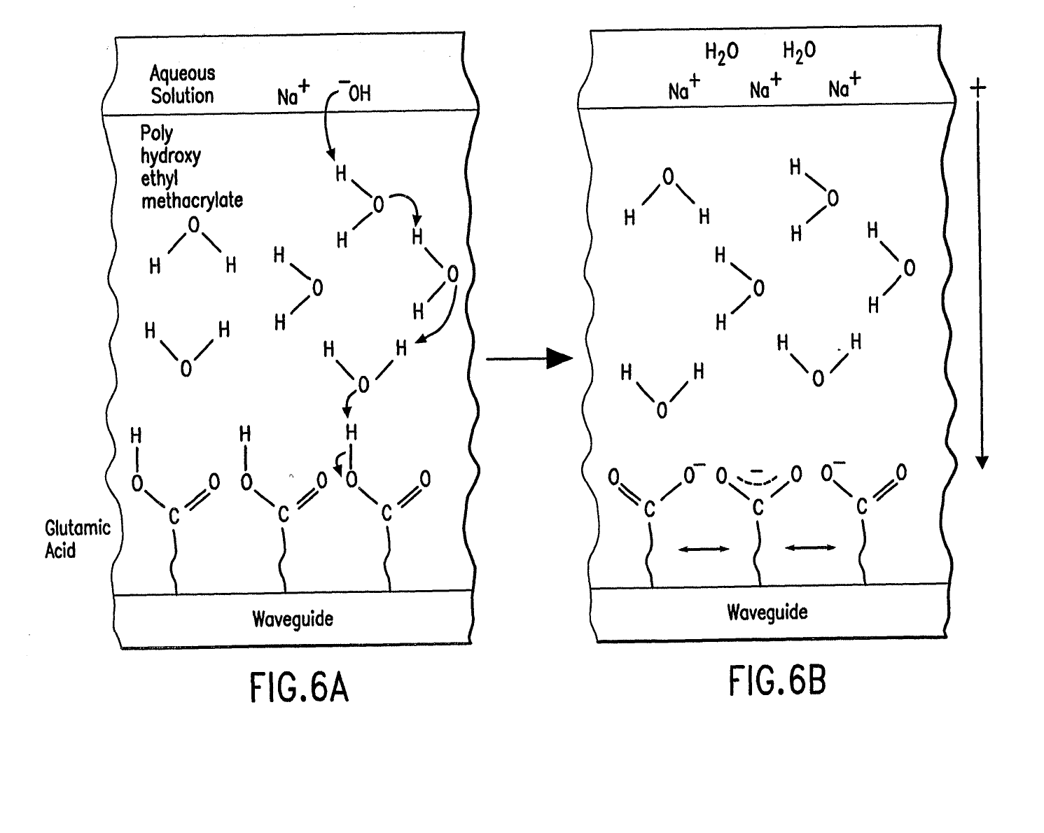

Not wishing to be bound by theory, it is believed that the overlayer facilitates proton transfer by permitting the passage of the acid or base or a proton being donated or accepted by the acid or base. The term “facilitate” refers to allowing or aiding proton transfer. The overlayer does not permit the passage of the conjugate acid or conjugate base or the counterion of the acid or base. As described above, a change in dipole or charge separation at or near the outer surface of the transducer results in a change in index of refraction. FIGS. 6a and 6b depict the increased charge separation when using an overlayer of the present invention when a transducer attached compound with a transducer attached compound functional group is chemically attached to the transducer by a silyl compound. In this embodiment, glutamic acid is covalently bonded to the transducer, and the overlayer is poly(2-hydroxyethyl methacrylate). In FIG. 6a, proton transfer occurs between the hydroxide ion and water molecules present within the overlayer. Proton transfer continues among the water molecules within the overlayer until the carboxylic acid of glutamic acid is deprotonated to produce the carboxylate (FIG. 6b). The overlayer prevents the counterion (Na⁺) from migrating toward the transducer, which results in a further increase in charge separation and in turn, a large change in index of refraction.

Depending upon the overlayer that is selected, the overlayer can be water insoluble but possess water-retaining properties. As more water partitions into and remains within the overlayer, the proton transfer between the acid or base and the functional group increases. By increasing the proton transfer, the response time of the sensor increases with respect to detecting or measuring the concentration of the acid or base or the pH. Additionally, by selecting the appropriate overlayer, it is possible to detect an acid or base, measure the concentration of an acid or base, or measure the pH of the environment, wherein the environment is an aqueous or organic media.

In another embodiment, an excluding layer is applied to (1) the outer surface of the transducer having a transducer attached compound, or (2) the outer surface of the overlayer, wherein a transducer attached compound is present or absent. In a preferred embodiment, the excluding layer is juxtaposed with the outer surface of the transducer or the overlayer. An overlayer can also act as an excluding layer.

One function or role of the excluding layer is to shield the transducer from undesirable environmental effects. The excluding layer can prevent solid contaminants and air bubbles from contacting the outer surface of the transducer. Additionally, the excluding layer can selectively block changes of index of refraction produced by the environment while detecting the presence of the particular acid or base. For example, there can be pores present in the excluding layer that are small enough to prevent contaminants and large molecules from penetrating the excluding layer and reaching the outer surface of the transducer. Thus, acids and bases, which are typically small molecules, may pass through the excluding layer while large molecules and contaminants remain in the environment. Finally, the excluding layer can protect the outer surface of the transducer, the transducer attached compound, or other underlying overlayers, because under extremely acidic or basic conditions, the transducer, the transducer attached compound, or other underlying overlayers can be damaged (e.g., dissolved or etched).

The thickness of the excluding layer can vary depending upon the environment and the composition of the overlayer. The excluding layer has a thickness of from 1 to 10,000 nm, preferably from 10 to 1,000 nm, more preferably from 100 to 800 nm, and even more preferably from 400 to 600 nm. In one embodiment, when the transducer produces an evanescent field, the excluding layer is thicker than the evanescent field.

Examples of excluding layers include, but are not limited to a porous glass, a sol-gel, a membrane, a wax, an ormosil (an organically modified silica), a polymer layer, or a combination thereof. When an overlayer and an excluding layer are used simultaneously, then the overlayer and excluding layer are not made of the same material. Specific examples of excluding layers include, but are not limited to, poly(butyl methacrylate-co-isobutyl methacrylate), hydroxypropyl cellulose, hydroxyethyl cellulose, ethyl cellulose, polytetrafluoroethylene, or poly(2,2-bistrifluoromethyl-4,5-difluoro-1,3-dioxole-co-tetrafluoroethylene), which is sold under the tradename TEFLON AF®, manufactured by DuPont. The excluding layer is preferably poly(2,2-bistrifltioromethyl-4,5-difluoro-1,3-dioxole-cotetrafluoroethylene).

In one embodiment, when an excluding layer is used in combination with an overlayer, the overlayer comprises poly(vinyl phenol), polystyrene sulfonate (sodium salt), polyethyleneimine, or poly(acrylic acid), and the excluding layer comprises poly(butyl methacrylate-co-isobutyl methacrylate), ethyl cellulose, hydroxypropyl cellulose, or hydroxyethyl cellulose. A specific embodiment includes, but is not limited to, the overlayer being polyethyleneimine-80% ethoxylated/citric acid and the excluding layer being poly(butyl methacrylate-co-isobutyl methacrylate).

The selection of the excluding layer, like the overlayer, can be varied in order to detect selectively a particular acid or base. The size of the pores present in the excluding layer or overlayer can determine which acids or bases can pass through the excluding layer or overlayer. For example, large, bulky amines may not pass through certain excluding layers or overlayers, while less sterically-hindered ammonia is readily passed.

The overlayer and excluding layer can be applied to the outer surface of the transducer using a variety of techniques known in the art. In one embodiment, when the overlayer or excluding layer is a polymer, the polymer can be applied to the outer surface of the transducer by Doctor blade, Langmuir Blodgett techniques, spin coating, dip coating, ink jet spraying, silk screening, plasma polymerization, or the overlayer or excluding layer can be applied to the outer surface of the transducer by a syringe or pipette.

III. Utilities of the Invention

The present invention can detect an acid or base in an environment, measure the concentration of an acid or base in an environment, or measure the pH of an environment.

The environment is any media that contains an acid or base. The acid is typically a Bronsted acid or Lewis acid and the base is a Bronsted base or Lewis base. Water is also considered an acid or a base depending upon the conditions of the environment.

The contacting step typically involves placing the transducer into an environment containing the acid or base. The environment containing the acid or base can also be passed over the transducer. The contacting step can be anywhere from seconds to months depending upon the environment being tested.

In various embodiments of the invention, the present invention can (1) detect the presence of an acid or base in the environment, that is it can detect acidic or basic conditions, or (2) detect the specific type of acid or base present in the environment.

One aspect of the present invention is that a variety of specific types of acids or bases can be detected. Acids and bases have unique pKa's (i.e., acid/base strengths that are a function of their molecular structure). By carefully choosing the pKa's of the functional groups on the sensing compounds, a particular sensor can be tailored to respond to only a limited number of acids or bases in the environment (i.e., only those acids or bases that match the pKa range of the sensing compounds). If the acid or base is absorbed by an overlayer, it is possible to identify the type of acid or base in the environment by appropriate selection of the partition coefficient, the index of refraction, and the pKa of the overlayer. The acids or bases that can be detected include, but are not limited to, acetic acid, hydrochloric acid, ammonia, methylamine or N-methylphenethlyamine, preferably ammonia.

Another aspect of the present invention is that the concentration of an acid or base can be measured. The acid or base being sensed is constantly captured and released by the functional groups on the sensing compounds, with an equilibrium between captured and uncaptured species determined by the concentration of the acid or base in the environment. As the concentration of the acid or base is increased, it pushes the equilibrium further toward the completed reaction (i.e., protonation or deprotonation) of all the functional groups in all of the sensing compounds, which in turn increases the change in index of refraction that is measured by the transducer, until saturation is reached. Calibrating the response of the transducer to different concentrations yields a sensor that not only detects the presence of the acid or base but also the concentration of the acid or base.

Transducer attached compounds that can be used to detect ammonia include, but are not limited to, 4-aminobenzoic acid, 4-aminobenzoic hydrazide, 4-hydroxybenzoic hydrazide, or 3-hydroxytyramine, wherein the transducer attached compound is attached to the outer surface of the transducer by a silyl compound or some other bonding.

When the sensor is used to detect ammonia, the sensor can comprise an overlayer and/or an excluding layer. Examples of the overlayer include, but are not limited to poly(vinyl phenol), poly(vinyl alcohol), polyimidazoline, polystyrene sulfonate (sodium salt), ethyl cellulose, hydroxypropyl cellulose, hydroxy ethyl cellulose, poly(2-hydroxyethyl methacrylate), or polyethyleneimine titrated with an acid, wherein the acid comprises citric acid, phosphoric acid, tartaric acid, maleic acid, or acetic acid. Examples of the excluding layer include, but are not limited to, poly(butyl methacrylate-co-isobutyl methacrylate), ethyl cellulose, hydroxypropyl cellulose, hydroxyethyl cellulose, poly(2-hydroxyethyl methacrylate), or poly(2,2-bistrifluoromethyl-4,5-difluoro-1,3-dioxole-co-tetrafluoroethylene).

In a preferred embodiment, when the sensor is used to detect ammonia, the overlayer comprises polyethyleneimine-80% ethoxylated/citric acid. In another preferred embodiment, when the sensor is used to detect ammonia, the overlayer is poly(vinyl phenol) and the excluding layer is ethyl cellulose. In another preferred embodiment, when the sensor is used to detect ammonia, a plurality of hydroxyl groups are directly attached to the outer surface of the transducer, and the overlayer is poly(vinyl alcohol).

Still another aspect of the present invention involves measuring the pH of the environment. Interaction of the environment with a functional group of the present invention (e.g., protonation or deprotonation) occurs over a pH range of 2 to 3 units, centered around the pKa of the functional group. As previously described, the interaction produces a change in charge, and therefore a change in dipole moment of the functional group, which in turn induces a change in index of refraction that is measured by the transducer. Some compounds of the present invention have multiple functional groups. For example, an amino acid has at least two. Protonation or deprotonation occurs around pH 2 for the carboxylic acid functional group and around pH 10 for the amino functional group, and protonation or deprotonation also occurs around a third pH range associated with the side functional group. A pH sensor with a broad range can be constructed by using a collection of amino acids that undergo protonation or deprotonation around different pH ranges. For example, using the side chain functionalities of glutamic acid (pKa=4.2), histidine (pKa=6.0), cysteine (pKa=8.3) and arginine (pKa=−12.5), permits the measurement of the pH at from 0 to 14 (including the protonation or deprotonation of the carboxylic acid and amino groups). Successively increasing the pH level will result in an increasing level of protonation or deprotonation, and in turn, an increasing change in charge, an increasing change in dipole moment, and an increasing change in index of refraction that can be measured by the transducer. The several amino acids can be used as individual compounds or synthesized into a single polypeptide.

Not wishing to be bound by theory, it is believed that when an overlayer is added to a sensor for measuring pH, the varying microenvironments thereby created spread the pKa response range of each functional group, which in turn broadens the pH response of the sensor.

Transducer attached compounds that can be used to detect the pH of the environment include, but are not limited to, histidine, glutamic acid, aspartic acid, tyrosine, 4-aminobenzoic hydrazide, arginine, cysteine, lysine, or the carboxylic acid of the oxidation product of 3-glycidyloxypropylmethoxysilane, or a combination thereof. In a preferred embodiment, when the sensor is used to measure the pH of the environment, (1) the transducer attached compound is a peptide comprising the repeat units of glutamic acid, aspartic acid, histidine, tyrosine, cysteine, lysine, arginine, or a combination thereof, wherein the peptide is attached to the outer surface of the transducer by a silyl compound and (2) the overlayer is poly(2-hydroxyethyl methacrylate).

IV. Sensors

In one aspect, the invention relates to a sensor for detecting an acid or base in an environment, measuring the concentration of an acid or base in an environment, or measuring the pH of an environment, comprising

(a) an index of refraction transducer having an outer surface;

(b) at least one compound comprising at least one functional group of a Lewis acid, a Lewis base, a Bronsted acid, a Bronsted base, or a combination thereof, wherein the compound is on or near the outer surface of the transducer, wherein the functional group can interact with the acid or base in the environment to induce a change in index of refraction on or near the outer surface of the transducer, with the provisos that

(i) the compound does not undergo a color change when contacted with the acid or base, and

(ii) when there are naturally occurring functional groups, no transducer attached compounds, and exactly one overlayer, then the overlayer is not poly(vinyl alcohol);

(c) a means for detecting or measuring the change of index of refraction, and

(d) a means for converting the change of index of refraction to a signal that corresponds to the detection of the acid or base in the environment, the concentration of the acid or base in the environment, or the pH of the environment.

In one embodiment, the compound is an amino acid or short peptide. Any of the amino acids listed in the previous sections can be used in this embodiment, which include all natural and non-natural amino acids. The term “short peptide” as used herein refers to a peptide chain composed of 2 to 100 amino acids. In various embodiments, the short peptide is composed of 2 to 10 amino acids, 11 to 50 amino acids, 2 to 50 amino acids, or 51 to 100 amino acids. In one embodiment, the amino acid or peptide is attached to the outer surface of the transducer by silane coupling chemistry as described in a previous section or by some other bonding. In a preferred embodiment, the short peptide comprises the repeat units of glutamic acid, aspartic acid, arginine, lysine, tyrosine, cysteine, histidine, or a combination thereof, wherein the short peptide is attached to the transducer by 3-glycidyloxypropyldimethylethoxysilane.

Additionally, any overlayer and excluding layer described above can be applied to outer surface of the transducer when an amino acid or short peptide is on or near the transducer. In a preferred embodiment, the overlayer is poly(2-hydroxyethyl methacrylate). In another preferred embodiment, (1) the compound is an amino acid, and the amino acid comprises glutamic acid, aspartic acid, arginine, lysine, tyrosine, cysteine, histidine, or a combination thereof, and (2) the overlayer is poly(2-hydroxyethyl methacrylate).

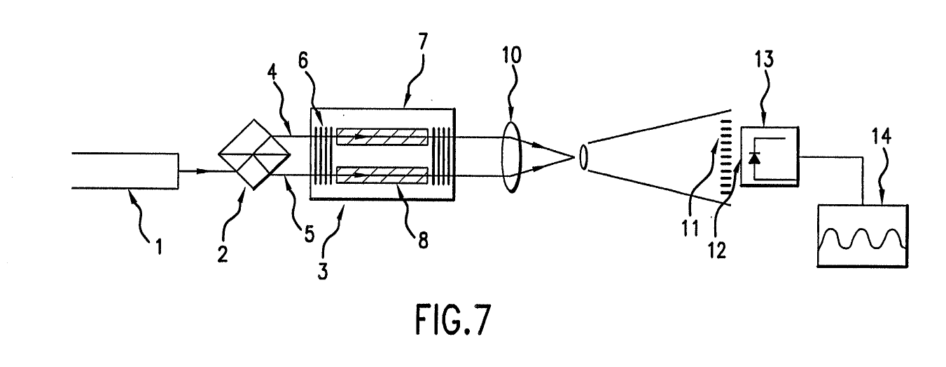

FIG. 7 depicts a planar waveguide interferometer, which is one transducer of the present invention used to detect or measure the acid or base in the environment or measure the pH of the environment. A laser (1) introduces a beam of light to a beam splitter (2), which splits the light into two beams. The two beams of light are directed to the planar waveguide (3). The first beam of light (4) and the second beam of light (5) initially pass through input gratings (6) and are coupled into the waveguide. The first beam of light is then guided through the test region (7), while the second beam of light is guided through the reference region (8).

The test region is where the transducer attached compound and/or overlayer of the present invention are attached and/or applied. The reference region can be buried under a thick layer of silicon dioxide. Alternatively, the reference region can be functionalized with a transducer attached compound and/or overlayer that will interact differently or not interact at all with the acid or base. As the acid or base interacts with transducer attached compound and/or the overlayer, the index of refraction of the test region increases or decreases relative to the index of refraction of the reference region. The increase or decrease of the index of refraction at the test region relative to the reference region is referred to herein as the “change of index of refraction.” The increase or decrease of the index of refraction results in a phase shift of the light that is propagated through the test region relative to the propagating light in the reference region.

Once the first and second beams pass through the output gratings (9) and are decoupled from the waveguide, the beams of light are combined by a lens (10). The resultant interference pattern (11), which varies in correspondence with the phase shift, is converted to a sinusoidal output (14) via a slit (12) and a detector (13). Using techniques known in the art, the sinusoidal output is then deconvolved to produce the total phase shift for the particular acid or base being detected, concentration of the acid or base, or the pH of the environment.

A variety of means for measuring and converting the change of index of refraction to a signal that corresponds to the detection or measurement of the acid or base in the environment or the measurement of the pH of the environment are known in the art. Such means are typically well known components of the specific type of index of refraction transducer employed.

### EXAMPLES

The following examples are put forth so as to provide those of ordinary skill in the art with a complete disclosure and description of how the methods and sensors claimed herein are evaluated, and are intended to be purely exemplary of the invention and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight for liquid environments and parts by volume for gaseous environments, target molecules are expressed in parts per million, temperature is in ° C. or is at ambient temperature and pressure is at or near atmospheric.

Transducer

The transducer used in Examples 1-6 is a planar waveguide interferometer. The planar waveguide portion of the interferometer is composed of a glass substrate with two pairs of gratings (i.e., an input and output grating) for each beam of light. The gratings are holographically rendered and ion etched into the substrate surface. A 140 nm layer of silicon nitride was deposited over the entire substrate, after which a 40 mm layer of silicon dioxide was deposited over the entire silicon nitride surface, which produces a single mode waveguide. For the planar waveguide used in Examples 1 and 4, an additional 500 nm layer of silicon dioxide was deposited over the gratings and the reference region to shield them from the environment. For the planar waveguides used in Examples 2, 3, 5, and 6, an additional 500 nm layer of silicon dioxide was deposited over the gratings only to shield them from the environment. A schematic drawing of the sensor can be found in FIG. 7, which was discussed above.

General Procedure for Attaching Glutamic Acid to the Outer Surface of the Waveguide via Silane Coupling

The glutamic acid used in Examples 2 and 3 was attached to the transducer using the following procedure. The glass surface of the waveguide was cleaned with hot chromic acid. Then the silane coupling agent, 3-glycidyloxypropyldimethylethoxysilane, was reacted with the hydroxyl groups on the glass surface on the waveguide. The epoxide of the silane was oxidized with sodium periodate under acidic conditions to generate the aldehyde. The amino group of glutamic acid was then coupled to the aldehyde through a reductive amination using NaBH₃CN.

Polymer Layer Coating Procedure

The polymers used in Examples 3, 4, 5, and 6 were applied to the transducer using the following procedure. The selected polymer was dissolved into an appropriate organic solvent, (typically toluene, methanol, or chloroform) at a concentration of from 50 to 150 mg/mL. The planar waveguide was then spin-coated or dip-coated with the polymer solution, and the thickness measured by profilometry. The planar waveguide was spin-coated or dip-coated repeatedly with different polymer solutions until the desired thickness was reached.

Experimental Setup for pH Measurement

A reservoir containing deionized water (500 mL) was connected to a flow cell attached to the surface of the planar waveguide via a tube. A separatory funnel containing the acid or base was positioned over the reservoir, and the amount of acid or base that was introduced into the reservoir was varied. A solution of 0.05 M phosphoric acid was dripped into the reservoir at 10 mL/min. The pH of the solution in the reservoir and the sensor was first brought down to a pH of 2 and then gradually increased to a pH of 11 by the addition of 0.05 M sodium hydroxide.

Prior to contacting the planar waveguide, the pH of the solution was measured by a glass electrode pH meter. The solution was then passed through the flow cell. The flow rate was typically 10 mL/min. The change in index of refraction was then correlated with the change in pH.

### Examples 1-3

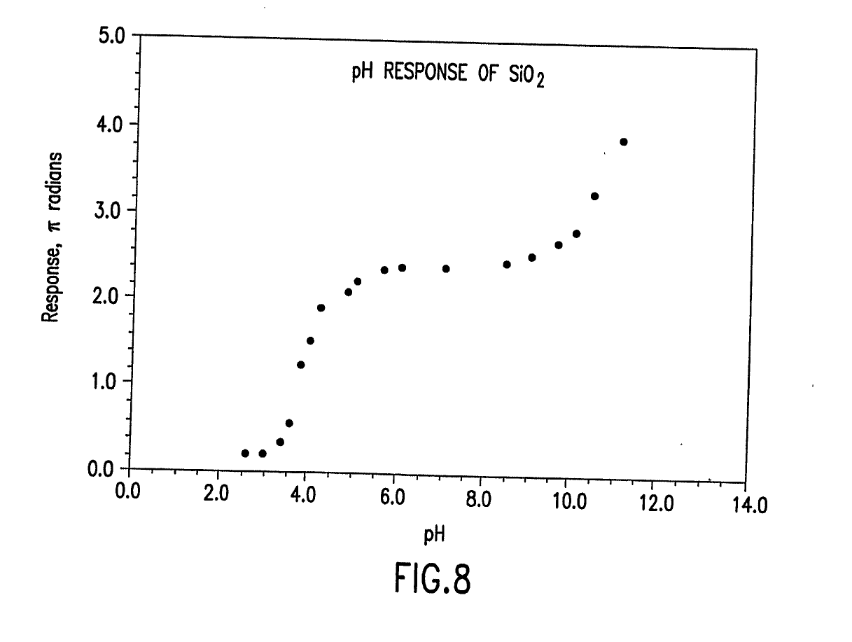

In Example 1, the planar waveguide outer surface was composed of silicon dioxide, which has naturally-occurring hydroxyl groups attached to it. FIG. 8 shows the pH response generated by the sensor of Example 1. The response produced by the sensor of Example 1 is fairly high; however, when the pH was increased to 11, the waveguide started to etch.

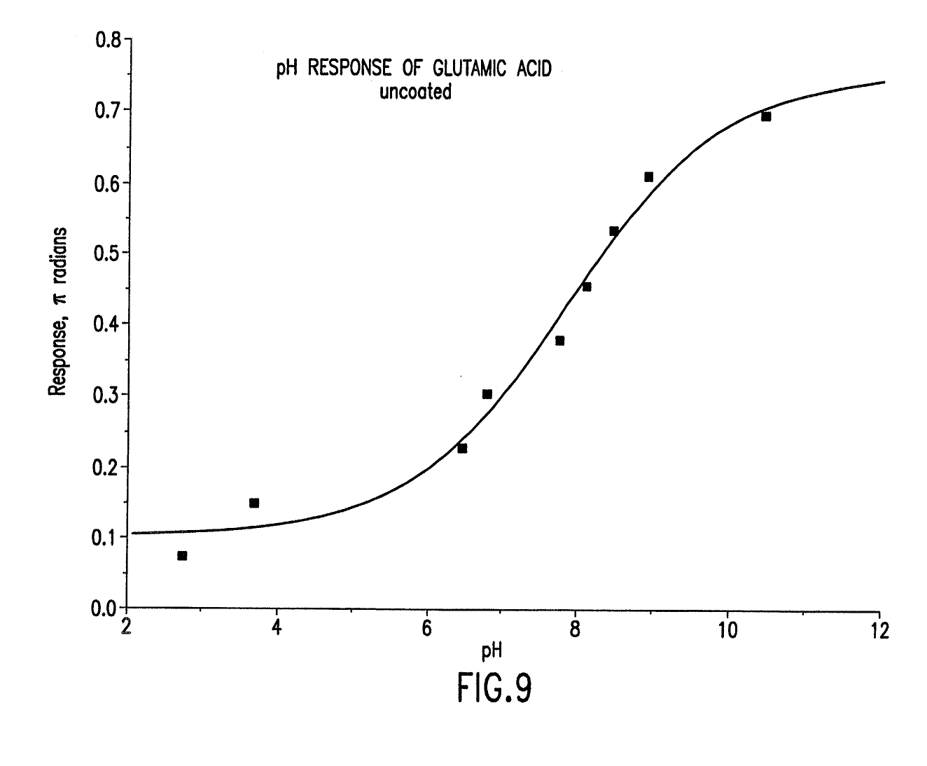

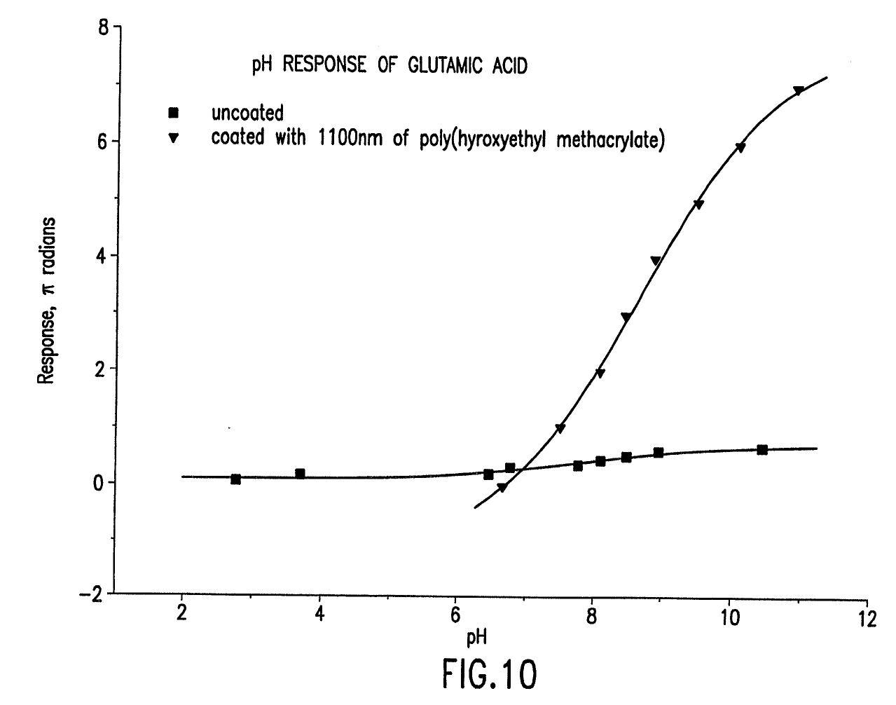

In Example 2, glutamic acid was attached to the outer surface of the test region of the planar waveguide. An inert film of poly(diallyl phthalate) was coated over the outer surface of the reference region of the planar waveguide. The pH response generated by the sensor of Example 2 can be found in FIG. 9. In Example 3, the sensor of Example 2 was coated with a 1,100 nm film of poly(hydroxyethyl methacrylate). The pH signal produced by this sensor of Example 3, which can be found in FIG. 10, was higher than the response produced in Examples 1 and 2. Additionally, the waveguide in Examples 2 and 3 did not etch when exposed to an environment with a high pH, which is not the case with Example 1.

Experimental Setup for Vapor Phase Ammonia Detection

An air pump provided air flow into the system. The air flowed into a carboy that served as a ballast to smooth out the air delivery. From the carboy, the air flow passed through a flow meter (approximately 750 mL/min) and contacted the waveguide via an inverted funnel. Ammonia in air (5%) was placed in a syringe pump. A syringe needle injected the solution directly into the air stream prior to reaching the funnel. The concentration of ammonia that was exposed to the waveguide was calculated from the air flow, the concentration of ammonia in the syringe, and the injection rate of the ammonia. For example, by injecting 1.5 mL/min of ammonia solution into an air flow stream of 750 mL/min produces an ammonia concentration at the output above the waveguide of 100 ppmv. By knowing the concentration of ammonia exposed to the waveguide, it was possible correlate the change in index of refraction to a concentration of ammonia in the vapor phase.

### Examples 4-6

In Example 4, the planar waveguide was coated with a 110 nm film of poly(vinyl alcohol). The sensor of Example 4 was disclosed in U.S. Pat. No. 5,623,561 to Hartman and is a comparative experiment. In Example 5, polyethyleneimine-80% ethoxylated, a base containing polymer which was titrated with citric acid, was applied to the outer surface of the test and reference regions of the planar waveguide. The test region had a 500 nm film titrated to a pH of 6.0, where one of the carboxylic acids of the citric acid was protonated. The reference region had a 500 nm film titrated to a pH of 8.0, where all of the carboxylic acid groups of citric acid were deprotonated. In Example 6, an 80 nm layer of poly(vinyl phenol) was applied to the outer surface of the test region of the planar waveguide, and a 150 nm layer of poly(vinyl phenoxide) was applied to the outer surface of the reference region of the planar waveguide. An additional 500 nm overlayer of ethyl cellulose was applied to the whole planar waveguide to bury the evanescent field.

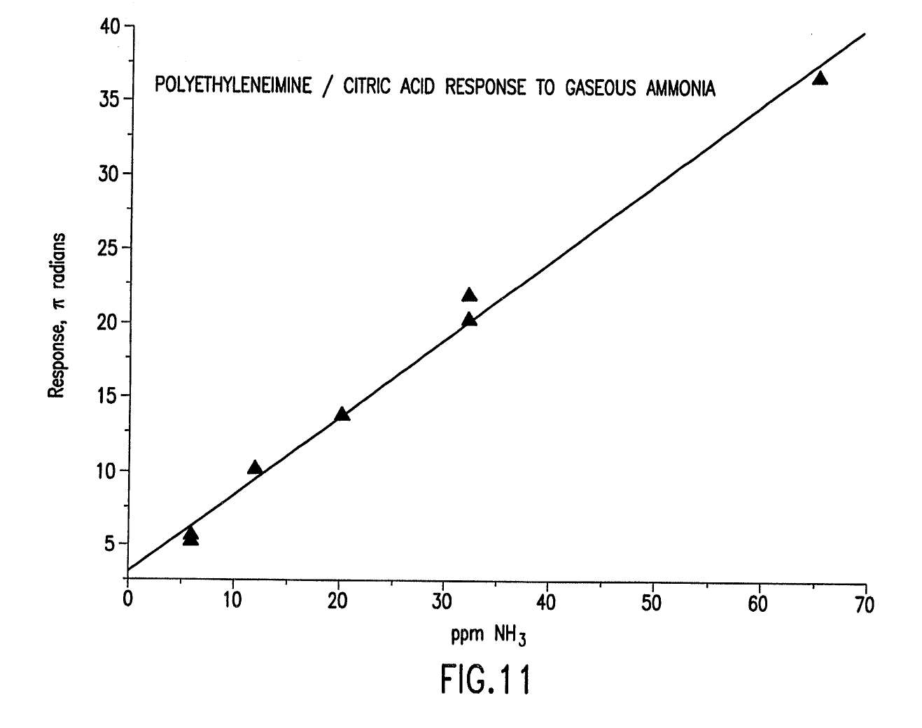

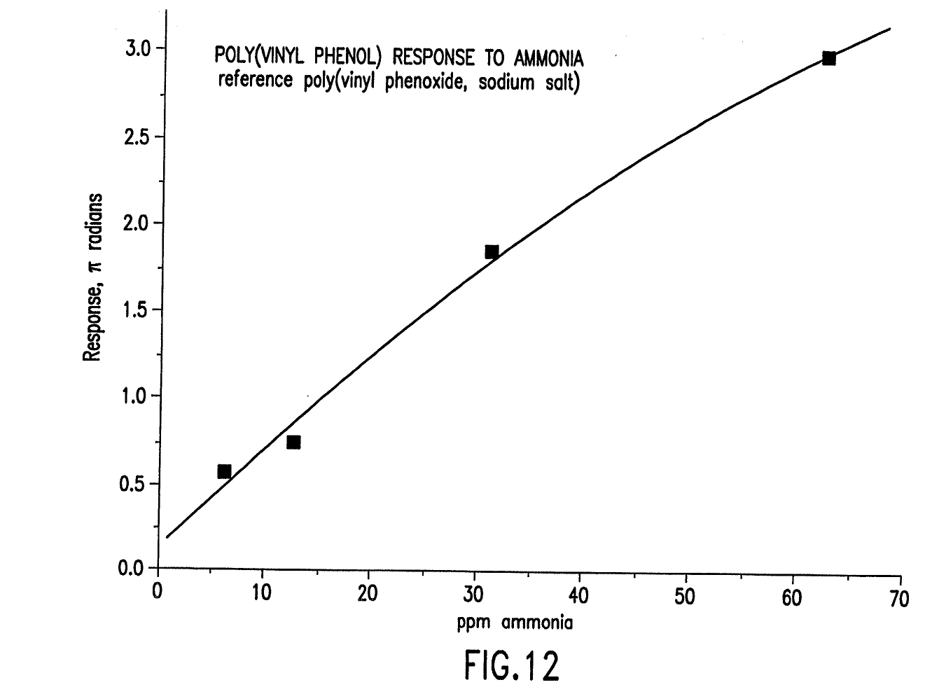

In Example 4, when the prior art sensor was contacted with 150 ppm of ammonia, the response produced by the signal varied from 0.25 to 1.25π radians. FIGS. 11 and 12 show the sensor's response to ammonia for Examples 5 and 6, respectively. The sensor of Example 5 shows a substantial increase in response when was contacted with ammonia as compared to the prior art sensor of Example 4. For example, when the concentration of the ammonia was approximately 60 ppm, the response was approximately 35π radians. The sensor of Example 6 also showed an increased response when contacted with ammonia as compared to the prior art sensor of Example 4. For example, when the sensor was contacted with approximately 60 ppm of ammonia, the response was approximately 3.0π radians. Thus, the data indicates that the sensors of the present invention (Examples 5 and 6) display an increased response when contacted with a lower concentration of ammonia as compared to the sensor disclosed in Hartman (Example 4).

Throughout this application, various publications are referenced. The disclosures of these publications in their entireties are hereby incorporated by reference into this application in order to more fully describe the state of the art to which this invention pertains.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only.

What is claimed is:

1. A method for detecting an acid or base in an environment, measuring the concentration of an acid or base in an environment, or measuring the pH of an environment, comprising
(a) contacting the environment comprising the acid or the base with a sensor, comprising
(1) an index of refraction transducer having an outer surface;
(2) at least one compound comprising at least one functional group of a Lewis acid, a Lewis base, a Bronsted acid, a Bronsted base, or a combination thereof, wherein the compound is on or near the outer surface of the transducer, wherein the functional group can interact with the acid or base in the environment to induce a change in index of refraction on or near the outer surface of the transducer, with the provisos that
(i) the compound does not undergo a color change when contacted with the acid or base, and
(ii) when there are naturally occurring functional groups, no transducer attached compounds, and exactly one overlayer, then the overlayer is not poly(vinyl alcohol);
(3) a means for detecting or measuring the change of index of refraction, and
(4) a means for converting the change of index of refraction to a signal that corresponds to the detection of the acid or base in the environment, the concentration of the acid or base in the environment, or the pH of the environment,
(b) measuring the change of index of refraction, and
(c) converting the change of index of refraction to a signal that corresponds to the detection of the acid or base in the environment, the concentration of the acid or base in the environment, or the pH of the environment.

2. A method for detecting an acid or base in an environment, measuring the concentration of an acid or base in an environment, or measuring the pH of an environment, comprising
(a) contacting the environment comprising an acid or a base with a sensor, comprising
(1) an index of refraction transducer having an outer surface;
(2) at least one compound comprising at least one functional group of a Lewis acid, a Lewis base, a Bronsted acid, a Bronsted base, or a combination thereof, wherein the compound is on or near the outer surface of the transducer, wherein the functional group can facilitate the transfer of at least one proton between the compound and the acid or base in the environment, wherein the transfer of the proton induces a change in the index of refraction on or near the outer surface of the transducer, with the provisos that
(i) the compound does not undergo a color change when contacted with the acid or base, and
(ii) when there are naturally occurring functional groups, no transducer attached compounds, and exactly one overlayer, then the overlayer is not poly(vinyl alcohol);
(3) a means for detecting or measuring the change of index of refraction, and
(4) a means for converting the change of index of refraction to a signal that corresponds to the detection of the acid or base in the environment, the concentration of the acid or base in the environment, or the pH of the environment,
(b) measuring the change of index of refraction, and
(c) converting the change of index of refraction to a signal that corresponds to the detection of the acid or base in the environment, the concentration of the acid or base in the environment, or the pH of the environment.

3. A method for detecting the presence of an acid or base in an environment, measuring the concentration of an acid or base in an environment, or measuring the pH of an environment, comprising
(a) contacting the environment comprising the acid or the base with a sensor, comprising
(1) an index of refraction transducer having an outer surface;
(2) at least one compound attached to the transducer comprising at least one transducer attached compound functional group of a Lewis acid, a Lewis base, a Bronsted acid, a Bronsted base, or a combination thereof, wherein the transducer attached compound is on or near the outer surface of the transducer, wherein the transducer attached compound functional group can interact with the acid or base in the environment to induce a change in index of refraction on or near the outer surface of the transducer, with the proviso that the compound does not undergo a color change when contacted with the acid or base;
(3) a means for detecting or measuring the change of index of refraction, and
(4) a means for converting the change of index of refraction to a signal that corresponds to the detection of the acid or base in the environment, the concentration of the acid or base in the environment, or the pH of the environment,
(b) measuring the change of index of refraction, and
(c) converting the change of index of refraction to a signal that corresponds to detecting the acid or base in the environment, the concentration of the acid or base in the environment, or the pH of the environment.

4. The method of claim 3, wherein (i) the transducer attached compound is indirectly attached to the outer surface of the transducer, (ii) the transducer attached compound is directly attached to the outer surface of the transducer, or a combination thereof.

5. The method of claim 3, wherein the transducer comprises a fiber optic evanescent wave sensor, a planar optic evanescent wave sensor, an integrated optic interferometer, a directional coupler, a grating coupler, a resonant mirror, an ellipsometer, a refractometer, or a surface plasmon resonance device.

6. The method of claim 3, wherein the Bronsted acid comprises water, a proton, a natural amino acid, a non-natural amino acid, a carboxylic acid, an organophosphoric acid, an organosulfuric acid, a protonated nitrogen compound, an alcohol, a thiol, an activated methylene compound, an organonitro compound, or a combination thereof.

7. The method of claim 3, wherein the Bronsted base comprises water, a hydroxide, a carboxylate, an organophosphonate, an organosulfonate, a neutral nitrogen compound, an alkoxide, a thioalkoxide, a conjugate base of a methylene compound, a conjugate base of an organonitro compound, an amino acid, an amine, an amide, an imine, or a combination thereof.

8. The method of claim 3, wherein the transducer attached compound is an amino acid comprising glutamic acid, aspartic acid, arginine, lysine, histidine, tyrosine, cysteine, or a combination thereof.

9. The method of claim 3, wherein the transducer attached compound is a peptide comprising the repeat units of glutamic acid, aspartic acid, arginine, lysine, histidine, tyrosine, cysteine, or a combination thereof.

10. The method of claim 3, wherein the sensor further comprises an excluding layer having an inner surface and an outer surface, wherein the inner surface of the excluding layer is applied to the outer surface of the transducer, wherein the excluding layer does not undergo a color change when contacted with the acid or base.

11. The method of claim 10, wherein the excluding layer comprises a porous glass, a sol-gel, a membrane, a wax, an ormosil, a polymer layer, or a combination thereof.

12. The method of claim 10, wherein the excluding layer comprises a polymer layer, and the polymer layer comprises poly(butyl methacrylate-co-isobutyl methacrylate), ethyl cellulose, hydroxypropyl cellulose, hydroxyethyl cellulose, polytetrafluoroethylene, or poly(2,2-bistrifluoromethyl-4,5-difluoro-1,3-dioxole-co-tetrafluoroethylene).

13. The method of claim 10, wherein the excluding layer has a thickness of from 1 to 10,000 nm.

14. The method of claim 10, wherein the excluding layer has a thickness of from 10 to 1,000 nm.

15. The method of claim 10, wherein the excluding layer has a thickness of from 400 to 600 nm.

16. The method of claim 3, wherein the environment comprises the gas phase, the liquid phase, or a combination thereof.

17. A method for detecting an acid or base in an environment, measuring the concentration of an acid or base in an environment, or measuring the pH of an environment, comprising
(a) contacting the environment comprising the acid or the base with a sensor, comprising
(1) an index of refraction transducer having an outer surface;
(2) at least one overlayer having an inner surface and an outer surface, wherein the overlayer has at least one overlayer compound having at least one overlayer compound functional group of a Lewis acid, a Lewis base, a Bronsted acid, a Bronsted base, or a combination thereof incorporated within the overlayer, wherein the overlayer compound is on or near the outer surface of the transducer, wherein the inner surface of the overlayer is applied to the outer surface of the transducer, wherein the overlayer compound functional group can interact with the acid or base in the environment to induce a change of index of refraction on or near the outer surface of the transducer, with the provisos that
(i) the compound does not undergo a color change when contacted with the acid or base, and
(ii) when there are naturally occurring functional groups, no transducer attached compounds, and exactly one overlayer, then the overlayer is not poly(vinyl alcohol);
(3) a means for detecting or measuring the change of index of refraction, and
(4) a means for converting the change of index of refraction to a signal that corresponds to the detection of the acid or base in the environment, the concentration of the acid or base in the environment, or the pH of the environment,
(b) measuring the change of index of refraction, and
(c) converting the change of index of refraction to a signal that corresponds to the detection of the acid or base in the environment, the concentration of the acid or base in the environment, or the pH of the environment.

18. The method of claim 17, wherein the transducer comprises a fiber optic evanescent wave sensor, a planar optic evanescent wave sensor, an integrated optic interferometer, a directional coupler, a grating coupler, a resonant mirror, an ellipsometer, a refractometer, or a surface plasmon resonance device.

19. The method of claim 17, wherein the Bronsted acid comprises water, a proton, a natural amino acid, a non-natural amino acid, a carboxylic acid, an organophosphoric acid, an organosulfuric acid, a protonated nitrogen compound, an alcohol, a thiol, an activated methylene compound, an organonitro compound, or a combination thereof.

20. The sensor of claim 17, wherein the Bronsted base comprises water, a hydroxide, a carboxylate, an organophosphonate, an organosulfonate, a neutral nitrogen compound, an alkoxide, a thioalkoxide, a conjugate base of a methylene compound, a conjugate base of an organonitro compound, an amino acid, an amine, an amide, an imine, or a combination thereof.

21. The method of claim 17, wherein the overlayer comprises a porous glass, a sol-gel, a membrane, a wax, an ormosil, a polymer layer, or a combination thereof.

22. The method of claim 17, wherein the overlayer comprises a polymer layer, wherein the polymer layer is a homopolymer, a copolymer, a terpolymer, or a combination thereof.

23. The method of claim 17, wherein the overlayer comprises
(a) at least one first overlayer having at least one first overlayer contained compound having at least one first overlayer contained compound functional group comprising a Lewis acid, Lewis base, Bronsted acid, a Bronsted base, or a combination thereof, wherein the first overlayer contained compound is contained in the first overlayer,
(b) at least one second overlayer having at least one second overlayer bonded compound having at least one second overlayer bonded compound functional group comprising a Lewis acid, a Lewis base, a Bronsted acid, or a Bronsted base, wherein the second overlayer bonded compound is covalently, ionically, or hydrogen bonded to the second overlayer, or
(c) at least one third overlayer comprising (1) at least one third overlayer bonded compound having at least one third overlayer bonded compound functional group comprising a Lewis acid, a Lewis base, a Bronsted acid, or a Bronsted base, wherein the third overlayer bonded compound is covalently, ionically, or hydrogen bonded to the third overlayer and (2) a third overlayer contained compound having at least one third overlayer contained compound functional group comprising a Lewis acid, a Lewis base, a Bronsted acid, or a Bronsted base, wherein the third overlayer contained compound is contained in the third overlayer, or a combination thereof.

24. The method of claim 23, wherein the overlayer comprises component (b) and the second overlayer is poly(vinyl phenol), polystyrene sulfonate (sodium salt), polyethyleneimine, or poly(acrylic acid).

25. The method of claim 23, wherein the overlayer comprises component (c) and (1) the third overlayer comprises poly(2-hydroxyethylmethacrylate) and (2) glutamic acid, aspartic acid, arginine, lysine, tyrosine, cysteine, histidine, or a combination thereof, and/or a peptide comprising the repeat units of glutamic acid, aspartic acid, arginine, lysine, tyrosine, cysteine, or histidine, or a combination thereof, is contained in the third overlayer.

26. The method of claim 17, wherein the overlayer has a thickness of from 1 to 10,000 nm.

27. The method of claim 17, wherein the overlayer has a thickness of from 10 to 1,000 nm.

28. The method of claim 17, wherein the overlayer has a thickness of from 400 to 600 nm.

29. The method of claim 17, wherein the sensor further comprises an excluding layer having an inner surface and an outer surface, wherein the inner surface of the excluding layer is applied to the outer surface of the transducer, wherein the excluding layer does not undergo a color change when contacted with the acid or base, wherein the excluding layer and the overlayer are not the same composition.

30. The method of claim 29, wherein the excluding layer comprises a porous glass, a sol-gel, a membrane, a wax, an ormosil, a polymer layer, or a combination thereof.

31. The method of claim 29, wherein the excluding layer comprises a polymer layer, and the polymer layer comprises poly(butyl methacrylate-co-isobutyl methacrylate), ethyl cellulose, hydroxypropyl cellulose, hydroxyethyl cellulose, polytetrafluoroethylene, or poly(2,2-bistrifluoromethyl-4,5-difluoro-1,3-dioxole-co-tetrafluoroethylene).

32. The method of claim 29, wherein (1) the overlayer comprises a polymer and the polymer comprises poly(vinyl phenol), polystyrene sulfonate (sodium salt), polyethyleneimine, or poly(acrylic acid), and (2) the excluding layer comprises a polymer layer and the polymer layer comprises poly(butyl methacrylate-co-isobutyl methacrylate), ethyl cellulose, hydroxypropyl cellulose, hydroxyethyl cellulose, or poly(2,2-bistrifluoromethyl-4,5-difluoro-1,3-dioxole-cotetrafluoroethylene).

33. The method of claim 29, wherein the excluding layer has a thickness of from 1 to 10,000 nm.

34. The method of claim 29, wherein the excluding layer has a thickness of from 10 to 1,000 nm.

35. The method of claim 29, wherein the excluding layer has a thickness of from 400 to 600 nm.

36. The method of claim 17, wherein the environment comprises the gas phase, the liquid phase, or a combination thereof.

37. A method for detecting the presence of an acid or base in an environment, measuring the concentration of an acid or base in an environment, or measuring the pH of an environment, comprising
(a) contacting the environment comprising the acid or the base with a sensor, comprising
(1) an index of refraction transducer having an outer surface;
(2) at least one compound attached to the transducer comprising at least one transducer attached compound functional group of a Lewis acid, a Lewis base, a Bronsted acid, a Bronsted base, or a combination thereof, wherein the transducer attached compound is on or near the outer surface of the transducer, wherein the transducer attached compound functional group can interact with the acid or base in the environment to induce a change in index of refraction on or near the outer surface of the transducer, wherein the transducer attached compound does not undergo a color change when contacted with the acid or base;
(3) at least one overlayer having an inner surface and an outer surface, wherein the overlayer has at least one overlayer compound having at least one overlayer compound functional group of a Lewis acid, a Lewis base, a Bronsted acid, a Bronsted base, or a combination thereof, incorporated within the overlayer, wherein the overlayer compound is on or near the outer surface of the transducer, wherein the inner surface of the overlayer is applied to the outer surface of the transducer, wherein the overlayer compound functional group can interact with the acid or base in the environment to induce a change of index of refraction on or near the outer surface of the transducer, with the proviso that the compound does not undergo a color change when contacted with the acid or base;
(4) a means for detecting or measuring the change of index of refraction, and
(5) a means for converting the change of index of refraction to a signal that corresponds to the detection of the acid or base in the environment, the concentration of the acid or base in the environment, or the pH of the environment,
(b) measuring the change of index of refraction, and
(c) converting the change of index of refraction to a signal that corresponds to detecting the acid or base in the environment, the concentration of the acid or base in the environment, or the pH of the environment.

38. The method of claim 37, wherein (i) the transducer attached compound is indirectly attached to the outer surface of the transducer, (ii) the transducer attached compound is directly attached to the outer surface of the transducer, or a combination thereof.

39. The method of claim 37, wherein the transducer comprises a fiber optic evanescent wave sensor, a planar optic evanescent wave sensor, an integrated optic interferometer, a directional coupler, a grating coupler, a resonant mirror, an ellipsometer, a refractometer, or a surface plasmon resonance device.

40. The method of claim 37, wherein the Bronsted acid comprises water, a proton, a natural amino acid, a non-natural amino acid, a carboxylic acid, an organophosphoric acid, an organosulfuric acid, a protonated nitrogen compound, an alcohol, a thiol, an activated methylene compound, an organonitro compound, or a combination thereof.

41. The method of claim 37, wherein the Bronsted base comprises water, a hydroxide, a carboxylate, an organophosphonate, an organosulfonate, a neutral nitrogen compound, an alkoxide, a thioalkoxide, a conjugate base of a methylene compound, a conjugate base of an organonitro compound, an amino acid, an amine, an amide, an imine, or a combination thereof.

42. The method of claim 37, wherein the transducer attached compound is an amino acid comprising glutamic acid, aspartic acid, arginine, lysine, histidine, tyrosine, cysteine, or a combination thereof.

43. The method of claim 37, wherein the transducer attached compound is a peptide comprising the repeat units of glutamic acid, aspartic acid, arginine, lysine, histidine, tyrosine, cysteine, or a combination thereof.

44. The method of claim 37, wherein the overlayer comprises a porous glass, a sol-gel, a membrane, a wax, an ormosil, a polymer layer, or a combination thereof.

45. The method of claim 37, wherein the overlayer comprises a polymer layer, wherein the polymer layer is a homopolymer, a copolymer, a terpolymer, or a combination thereof.

46. The method of claim 37, wherein the overlayer comprises
(a) at least one first overlayer having at least one first overlayer contained compound having at least one first overlayer contained compound functional group comprising a Lewis acid, Lewis base, Bronsted acid, a Bronsted base, or a combination thereof, wherein the first overlayer contained compound is contained in the first overlayer,
(b) at least one second overlayer having at least one second overlayer bonded compound having at least one second overlayer bonded compound functional group comprising a Lewis acid, a Lewis base, a Bronsted acid, or a Bronsted base, wherein the second overlayer bonded compound is covalently, ionically, or hydrogen bonded to the second overlayer, or
(c) at least one third overlayer comprising (1) at least one third overlayer bonded compound having at least one third overlayer bonded compound functional group comprising a Lewis acid, a Lewis base, a Bronsted acid, or a Bronsted base, wherein the third overlayer bonded compound is covalently, ionically, or hydrogen bonded to the third overlayer and (2) a third overlayer contained compound having at least one third overlayer contained compound functional group comprising a Lewis acid, a Lewis base, a Bronsted acid, or a Bronsted base, wherein the third overlayer contained compound is contained in the third overlayer, or a combination thereof.

47. The method of claim 46, wherein the overlayer comprises component (b) and the second overlayer is poly(vinyl phenol), polystyrene sulfonate (sodium salt), polyethyleneimine, or poly(acrylic acid).

48. The method of claim 46, wherein the overlayer comprises component (c) and (1) the third overlayer comprises poly(2-hydroxyethyl methacrylate) and (2) glutamic acid, aspartic acid, arginine, lysine, tyrosine, cysteine, histidine, or a combination thereof, and/or a peptide comprising the repeat units of glutamic acid, aspartic acid, arginine, lysine, tyrosine, cysteine, or histidine, or a combination thereof, is contained in the third overlayer.

49. The method of claim 37, wherein (1) the transducer attached compound is an amino acid comprising glutamic acid, aspartic acid, arginine, lysine, tyrosine, cysteine, histidine, or a combination thereof, and (2) the overlayer comprises poly(2-hydroxyethyl methacrylate).

50. The method of claim 37, wherein (1) the transducer attached compound is a peptide comprising the repeat units of glutamic acid, aspartic acid, arginine, lysine, tyrosine, cysteine, or histidine or a combination thereof, and (2) the overlayer comprises poly(2-hydroxyethyl methacrylate).

51. The method of claim 37, wherein the overlayer has a thickness of from 1 to 10,000 n.

52. The method of claim 37, wherein the overlayer has a thickness of from 10 to 1,000 nm.

53. The method of claim 37, wherein the overlayer has a thickness of from 400 to 600 nm.

54. The method of claim 37, wherein the sensor further comprises an excluding layer having an inner surface and an outer surface, wherein the inner surface of the excluding layer is applied to the outer surface of the transducer, wherein the excluding layer does not undergo a color change when contacted with the acid or base, wherein the excluding layer and the overlayer are not the same composition.

55. The method of claim 54, wherein the excluding layer comprises a porous glass, a sol-gel, a membrane, a wax, an ormosil, a polymer layer, or a combination thereof.

56. The method of claim 54, wherein the excluding layer comprises a polymer layer, and the polymer layer comprises poly(butyl methacrylate-co-isobutyl methacrylate), ethyl cellulose, hydroxypropyl cellulose, hydroxyethyl cellulose, polytetrafluoroethylene, or poly(2,2-bistrifluoromethyl-4,5-difluoro-1,3-dioxole-co-tetrafluoroethylene).

57. The method of claim 54, wherein the excluding layer has a thickness of from 1 to 10,000 nm.

58. The method of claim 54, wherein the excluding layer has a thickness of from 10 to 1,000 nm.

59. The method of claim 54, wherein the excluding layer has a thickness of from 400 to 600 nm.

60. The method of claim 37, wherein the environment comprises the gas phase, the liquid phase, or a combination thereof.

61. A sensor for detecting an acid or base in an environment, measuring the concentration of an acid or base in an environment, or measuring the pH of an environment, comprising
(a) an index of refraction transducer having an outer surface;
(b) at least one compound comprising at least one functional group of a Lewis acid, a Lewis base, a Bronsted acid, a Bronsted base, or a combination thereof, wherein the compound is on or near the outer surface of the transducer, wherein the functional group can interact with the acid or base in the environment to induce a change in index of refraction on or near the outer surface of the transducer, with the provisos that
(i) the compound does not undergo a color change when contacted with the acid or base, and
(ii) when there are naturally occurring functional groups, no transducer attached compounds, and exactly one overlayer, then the overlayer is not poly(vinyl alcohol);
(c) a means for detecting or measuring the change of index of refraction, and
(d) a means for converting the change of index of refraction to a signal that corresponds to the detection of the acid or base in the environment, the concentration of the acid or base in the environment, or the pH of the environment.

62. The sensor of claim 61, wherein the compound comprises an amino acid or a short peptide.

63. The sensor of claim 62, wherein the compound is an amino acid, and the amino acid comprises glutamic acid, aspartic acid, arginine, lysine, tyrosine, cysteine, histidine, or a combination thereof.

64. The sensor of claim 62, wherein the compound is a short peptide, and the short peptide comprises the repeat units of glutamic acid, aspartic acid, arginine, lysine, tyrosine, cysteine, histidine, or a combination thereof.

65. The sensor of claim 62, wherein the sensor further comprises an overlayer.

66. The sensor of claim 65, which (1) the compound is an amino acid, and the amino acid comprises glutamic acid, aspartic acid, arginine, lysine, tyrosine, cysteine, histidine, or a combination thereof, and (2) the overlayer is poly(2-hydroxyethyl methacrylate).

67. The sensor of claim 65, wherein (1) the compound is a short peptide, and the short peptide comprises the repeat units of glutamic acid, aspartic acid, arginine, lysine, tyrosine, cysteine, histidine, or a combination thereof, and (2) the overlayer is poly(2-hydroxyethyl methacrylate).
